(19) United States
(12) Patent Application Publication
(10) Pub. No.: US 2012/0107787 A1
(43) Pub. Date: May 3, 2012

(54) ADVISORY SERVICES NETWORK AND ARCHITECTURE

(75) Inventors: Dana Zimmerman, Seattle, WA (US); Jonathan Grudin, Issaquah, WA (US); Pallaw Sharma, Issaquah, WA (US); Warwick Holder, Redmond, WA (US); Alistair Lowe-Norris, Issaquah, WA (US); Rick Maguire, Bainbridge Island, WA (US); Donald Brinkman, Seattle, WA (US); Frank Martinez, Seattle, WA (US)

(73) Assignee: Microsoft Corporation, Redmond, WA (US)

(21) Appl. No.: 13/079,464

(22) Filed: Apr. 4, 2011

Related U.S. Application Data
(60) Provisional application No. 61/409,013, filed on Nov. 1, 2010.

(51) Int. Cl. G09B 7/00

(52) U.S. Cl. 434/322

(57) ABSTRACT

Systems and methods are provided to implement an advisory services network that enables organizations to identify complex business problems from apparent business problems, immerse a diverse group of people in the businesses of the organizations, and promote collaboration to develop viable solutions to the complex business problems. An enterprise organization can supply case studies of real-life scenarios, data, ethnographic interviews to convey multiple views of problematic areas, etc., to enable members of the diverse group of people to immerse themselves into the problem space, participate in creative communications, such as discussions, and brainstorm potential solutions. Further, the advisory services network can include a gaming platform on which instances of serious games can be developed and deployed. The serious games enables sharing of ideas among players, discussions among players, and other player interactions to facilitate compounding of perspectives and solutions among a diverse group while providing an entertaining and through-provoking environment.

### CROSS-REFERENCE TO RELATED APPLICATIONS

This application claims priority to U.S. Provisional Application Ser. No. 61/409,013, filed on Nov. 1, 2010, entitled “ADVISORY SERVICES NETWORK AND ARCHITECTURE”, the entirety of which is incorporated herein by reference.

### TECHNICAL FIELD

The subject disclosure relates to architectures of an advisory services network configured to leverage a plurality of participants to generate solutions to complex problems for which a solution is not yet apparent and architectures of a gaming platform of the advisory services network configured to immerse the plurality of participants in a game environment to facilitate solution generation.

### BACKGROUND

In enterprise business, the importance of information technology (IT) is ever increasing. Large enterprise organizations rely more and more on robust technology products and related services to support their businesses. Over the past several decades, a large consulting services industry has developed to support and service these large enterprise organizations. Typically, consulting organizations apply one model in executing consulting services. This model involves top-performing, senior level consultants developing customer service partnerships with large enterprise organizations. The senior level consultants leverage a large number of junior consultants to design IT solutions. This model, however, is not easily scalable, it is labor intensive and thus expensive, and does not guarantee quality results. In addition, consulting organizations attempt to leverage previous solutions, developed for other customers, as a means for raising profit margins. This approach leads to non-differentiated solutions which partially address core problems of the enterprises.

Enterprise organizations seek the assistance of consultants to identify, analyze, and solve complex business problems. Complex business problems, as the name suggests, can be extremely complex, and result from various factors. For instance, complex business problems can arise from a series of business changes, rapid growth of businesses, technology changes, and/or technological limitations.

Enterprise organizations, who understand their businesses to a greater extent than consulting firms, desire a collaborative approach in which the enterprise organizations and consulting firms work closely to develop creative business solutions for complex problems. Accordingly, it can be beneficial to leverage business knowledge, held by the enterprise organizations, to immerse a team of consultants into the problems faced by the enterprise organizations in order to develop effective solutions.

One possible immersion mechanism is “serious” games. Serious games can encompass many forms and subject matters and teach players information relating to education, health, science, law and government, computers, and/or a multitude of other subjects. Typically, computer games are designed for entertainment purposes. However, with serious games, the goal is to train and educate players through a planned curriculum and set of objectives. Players can learn new material in a fun, educational environment. Conventional serious games, while challenging, are not aimed at real-life business problems nor provide clear problems statements and solutions which can be implemented by enterprise organizations. Rather, conventional serious games are designed to look at societal weaknesses and/or extreme world disaster scenarios, in the world and in the future, without regard to the existence of workable solutions.

Another challenge with consulting services and immersion mechanisms arises due to the sheer complexity of problems faced by enterprise organizations. For example, complex problems can involve vast amounts of data which can require research and analysis by a wide array of experts to comprehend the complex situations presented by the complex problems and any possible implications. Enterprise organizations can spend countless hours building data portfolios containing details which summarize the what, why, when, where, who, and how of a complex business problem. After data compilation, experts read, parse, review, and absorb all the information in order to develop a reasonable problem statement.

Reviewing volumes of data takes time and money due to people researching and creating systematic approaches to reduce the volumes of data into a reasonable problem concept. Housing the volumes of data within a serious game can reduce an amount of data flow between experts as the information is retained within a single environment. However, the experts continue to expend significant and time consuming effort to reduce the volumes of data into a problem statement. Moreover, the volumes of data can be of such a scale that no individual can search, review, or utilize all the various media types in the volumes of data, emerge with knowledge of all the material, and utilize that knowledge to the benefit of the enterprise organizations. With conventional data research, a challenge exists with analyzing and finding relevant content in the volumes of data and to discover an overall pattern within the volumes of data.

The above-described deficiencies of conventional consulting solutions are merely intended to provide an overview of some of the problems of conventional systems and techniques, and are not intended to be exhaustive. Other problems with conventional systems and techniques, and corresponding benefits of the various non-limiting embodiments described herein may become further apparent upon review of the following description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In various, non-limiting embodiments, an advisory services network is provided that enables enterprise organizations to identify complex business problems from apparent business problems, immerse a diverse group of people in the businesses of the enterprise organizations, and promote collaboration to develop viable solutions to the complex business problems. An enterprise organization can supply a collection of data to enable members of the diverse group of people to immerse themselves into the problem space, participate in creative communications, such as discussions, and brainstorm potential solutions. The advisory services network can include a gaming platform on which instances of serious games can be developed and deployed. Serious games deployed on the gaming platform guide players (e.g., members of the diverse group of people sourced by the advisory services network) through a thought-provoking environment in which the players uncover idiosyncrasies and complexities of the business of an enterprise organization. Through the serious games on the gaming platform, players are immersed in the problem space of the enterprise organization. The players are encouraged to identify real problems of the enterprise organization, for which solutions are currently unknown, and develop potential solutions to those real problems. The gaming platform further enables sharing of ideas among players, discussions among players, and other player interactions to facilitate compounding of perspectives and solutions among a diverse group.

These and other embodiments are described in more detail below.

### BRIEF DESCRIPTION OF THE DRAWINGS

Various non-limiting embodiments are further described with reference to the accompanying drawings in which:

FIG. 1 is a block diagram illustrating an exemplary, non-limiting advisory services network for sourcing a group to develop solutions to complex problems;

FIG. 2 is a flow diagram illustrating an exemplary, non-limiting embodiment for developing solutions to complex business problems via crowd sourcing;

FIG. 3 is a block diagram illustrating an exemplary, non-limiting advisory services network, implemented on a computing system, configured to facilitate crowd sourcing;

FIG. 4 is a flow diagram illustrating an exemplary, non-limiting embodiment for populating an advisory services network with information related to a complex problem to facilitate problem solving;

FIG. 5 is a block diagram illustrating an exemplary, non-limiting act of adding supporting evidence, related to a complex problem, to an advisory services network;

FIG. 6 is a flow diagram illustrating an exemplary, non-limiting embodiment for enabling a digital dossier within an advisory services network;

FIG. 7 is a block diagram illustrating an exemplary, non-limiting act of managing a digital dossier of an advisory services network;

FIG. 8 is a flow diagram of an exemplary, non-limiting embodiment for managing social interactions among a plurality of participants of an advisory services network;

FIG. 9 is a block diagram of an exemplary, non-limiting act of maintaining and representing social interactions among participants of an advisory services network;

FIG. 10 illustrates an exemplary, non-limiting aspect of leveraging social media discussions through multiple media sources;

FIG. 11 illustrates exemplary, non-limiting variations on how discussions can link to multiple media types and other discussions;

FIG. 12 illustrates exemplary, non-limiting relationships between media types in accordance with one or more embodiments;

FIG. 13 is a block diagram illustrating an exemplary, non-limiting embodiment of an advisory services network implemented as a gaming platform;

FIG. 14 is a block diagram of an exemplary, non-limiting embodiment of a gaming platform, hosting a game instance, of an advisory services network;

FIG. 15 illustrates a flow diagram of an exemplary, non-limiting embodiment for a gaming environment which immerses players in a business of an enterprise organization facing a complex business problem;

FIG. 16 is an exemplary, non-limiting illustration of a user interface of a gaming environment of an advisory services network;

FIG. 17 is a block diagram illustrating an exemplary, non-limiting gaming platform in accordance with one or more embodiments;

FIG. 18 is a flow diagram of an exemplary, non-limiting embodiment for interacting with a player of a game via player input;

FIG. 19 is a block diagram of an exemplary, non-limiting act of handling player input;

FIG. 20 is a flow diagram illustrating an exemplary, non-limiting embodiment for browsing evidence items stored in a game on an advisory services network;

FIG. 21 is a block diagram illustrating an exemplary, non-limiting act of browsing evidence within a game on an advisory services network;

FIG. 22 is a flow diagram of an exemplary, non-limiting embodiment for navigating between scenes of a game of an advisory services network;

FIG. 23 is a block diagram of an exemplary, non-limiting act of navigating between scenes of a game of an advisory services network;

FIG. 24 is a flow diagram of an exemplary, non-limiting embodiment for managing a digital dossier within a game of an advisory services network;

FIG. 25 is a block diagram illustrating an exemplary, non-limiting act of managing a digital dossier within a game of an advisory services network;

FIG. 26 is a flow diagram illustrating an exemplary, non-limiting embodiment for managing social interactions within a game of an advisory services network;

FIG. 27 is a block diagram illustrating an exemplary, non-limiting act of managing social interactions within a game of an advisory services network;

FIG. 28 is a flow diagram illustrating an exemplary, non-limiting embodiment for creating a game instance within an advisory services network;

FIG. 29 is a block diagram of an exemplary, non-limiting act of building a game instance within an advisory services network;

FIG. 30 is a flow diagram of an exemplary, non-limiting embodiment of building a game instance within an advisory services network;

FIG. 31 is a flow diagram illustrating an exemplary, non-limiting embodiment for creating a narrative scene of a game instance within an advisory services network;

FIG. 32 is a block diagram illustrating an exemplary, non-limiting act of building a game instance within an advisory services network;

FIG. 33 is a block diagram representing exemplary non-limiting networked environments in which various embodiments described herein can be implemented; and

FIG. 34 is a block diagram representing an exemplary non-limiting computing system or operating environment in which one or more aspects of various embodiments described herein can be implemented.

### DETAILED DESCRIPTION

### General Overview

As discussed in the background, conventional consulting services employ a non-scalable and expensive business model that often produces non-differentiated solutions to enterprise organizations facing complex problems. In addition, a large volume of information is typically associated with the complex problems, which requires a significant effort to absorb and understand. Accordingly, conventional consulting services cannot cost effectively immerse themselves in the business of enterprise organizations in order to provide high quality, viable solutions to complex problems.

In various, non-limiting embodiments, an advisory services network is provided that enables enterprise organizations to identify complex business problems from apparent business problems, immerse a diverse group of people in the businesses of the enterprise organizations, and promote collaboration to develop viable solutions to the complex business problems. An enterprise organization can supply case studies of real-life scenarios, data, ethnographic interviews to convey multiple views of problematic areas, etc., to enable members of the diverse group of people to immerse themselves into the problem space, participate in creative discussions, and brainstorm potential solutions. In addition to immersion, the advisory services network can improve solution building processes through identification of subject matter experts. The subject matter experts, drawn from the diverse group of players interacting in the advisory services network, can collaborate, co-innovate, and problem solve in a virtual team environment fostered by the advisory services network.

According to a further embodiment, the advisory services network can include a gaming platform on which instances of serious games can be developed and deployed. Serious games deployed on the gaming platform guide players (e.g., members of the diverse group of people sourced by the advisory services network) through a thought-provoking environment in which the players uncover idiosyncrasies and complexities of the business of an enterprise organization. Through the serious games on the gaming platform, players are immersed in the problem space of the enterprise organization. The players are encouraged to identify real problems of the enterprise organization and develop potential solutions to those real problems. The gaming platform further enables sharing of ideas among players, discussions among players, and other player interactions to facilitate compounding of perspectives and solutions among a diverse group.

In yet another embodiment, a game builder is provided to enable creation of game instances within the gaming platform. A sponsor (e.g., an organization with a complex problem, a consultant attempting to solve a complex problem, etc.) can plug in the pieces for a specific game and the game builder constructs a corresponding game instance which can be played by a plurality of diverse players. For instance, the sponsor can supply various media and other content such as, but not limited to, a back story, videos (e.g., ethnographic videos, instructional videos, etc.), documents, game challenges, narrative scenes, game rules, point schedules, and the like. The sponsor, through the game builder, can construct a variety of game types. By way of example, the game is not limited to a fact-finding mission style and the sponsor can supply a setting to facilitate engaging people in a community, troubleshoot issues, or to provide a fun outlet for players. The gaming platform does not impose restrictions on how gaming instances are utilized. Games can be employed to facilitate definition of a problem, to crowd source a solution, to connect people through discussion and other social interactions, to engage people to collaborate and develop new innovations, or as a fun environment for people to unwind in a back story and challenge themselves to develop creative solutions.

The game builder enhances configurability of the gaming platform as well as gaming instances created thereon. The game builder enables the sponsor to select a population to which to crowd source and enables the sponsor to select, for inclusion, and to configure various gaming features (e.g., dossiers, discussion boards, chat systems, point systems, etc.).

In one embodiment, an advisory services system is described herein that includes an evidence store configured to retain a set of media items related to a real-world problem of an entity, a browsing module configured to retrieve an item from the set of media items stored in the evidence store and provide the item retrieved for review by a user of the advisory services system, a social interaction module configured to manage a discussion board through which a plurality of users drawn from a diverse group engage in discussions regarding media items in the set of the media items stored by the evidence store, and an interaction store configured to retain artifacts generated from interaction input from the plurality of users, wherein the artifacts represent the discussion board and discussions hosted on the discussion board. In an example, the browsing module and the social interaction module enable the plurality of users to collaborate to devise a solution for the real-world problem of the entity. In another example, the set of media items include ethnographic information regarding the entity and the real-world problem of the entity.

According to further embodiments, the advisory services system can include an evidence index module configured to receive the set of media items from the entity and store the set of media items in the evidence store. In another embodiment, the advisory services system can include an interface module configured to generate a user interface displayed to the plurality of users and to obtain user input from the plurality of users, wherein the interface module is further configured to forward the user input to one or more of the browsing module or the social interaction module based at least in part upon a content of the user input.

Further yet, the advisory services system can include a dossier store configured to store a digital dossier associated with the user of the advisory services system, wherein the digital dossier retains one or more media items selected, in response to input from the user, from the set of media items stored in the evidence store and a dossier module configured to manage the digital dossier stored in the dossier store in accordance with a dossier command received from the user. In an example, the dossier module is further configured to, in response the dossier command, at least one of add a media item from the set of media items stored in the evidence store to the digital dossier, remove items from the digital dossier, reorder items in the digital dossier, or publish the digital dossier to a discussion thread managed by the social interaction module.

According to further embodiments, a method is described herein that includes obtaining a set of media and configuration information from an entity with a real-world problem for which for which a solution is yet to be found, instantiating a network game based upon the set of media and the configuration information, and deploying the network game on a gaming platform, wherein a diverse group of players interact and collaborate via the network game to solve the real-world problem based upon the set of media. In an example, instantiating the network game can include storing a set of evidence included in the set of media in an evidence store associated with the network game, storing a set of narrative scenes include in the set of media in a scene information store of the network game, linking the set of narrative scenes based upon the configuration information to generate a graph of narrative scenes representing a plurality of paths among the narrative scenes navigable by the diverse group of players within the network game, and associating a subset of evidence from the set of evidence with each narrative scene from the set of narrative scenes.

In a further embodiment, the method can include receiving input from a player via a user interface of the network game, evaluating the input based upon a state of the network game, generating a set of commands for executing actions in response to the input, and issuing the set of commands to a set of subsystems of the network game. In addition, the method can include receiving a selection command from a player of the network game, retrieving one or more items of evidence from the set of evidence stored in the evidence store based upon the selection command, and displaying the one or more items of evidence to the player on a user interface of the network game. The method can also include receiving a navigation command from a player of the network game, retrieving a narrative scene from the set of narrative scenes stored in the scene information store based upon the navigation command, and displaying the narrative scene on a user interface.

Further, the method can include receiving a dossier command from a player of the network game, obtaining a data item from a disparate subsystem of the network game when the dossier command is an add command, and modifying a dossier corresponding to the player based upon the dossier command. In an example, obtaining the data item includes at least one of obtaining an item of evidence from the set of evidence stored in the evidence store, obtaining a artifact of a social interaction made via the network game from an interaction store, or obtaining a second dossier corresponding to a second player. In another example, modifying the dossier corresponding other player includes at least one of adding the data item from the disparate subsystem of the network game to the dossier, removing a first dossier item from the dossier, or modifying metadata associated with a second dossier item from the dossier.

In a further embodiment, the method can include receiving a social interaction command from a player of the network game, generating an interaction artifact based upon a social interaction indicated in the social interaction command, and storing the interaction artifact in a social interaction store of the network game. In an example, the method can further include obtaining a referenced data item when specified in the social interaction command, determining relationship metadata associated with the interaction artifact and the reference data item, and storing the relationship metadata in the social interaction store in association with the interaction artifact. In a further example, the method can include updating relationship metadata associated with disparate interaction artifacts affected by the social interaction command form the player.

In an additional embodiment, a gaming platform of an advisory services network is described herein that includes a game engine associated with an instance of a game and configured to manage execution of the game, wherein the game involves a variety of players who attempt to solve a real-world problem for which a solution is yet to be found based on evidence input to the game. The gaming platform also includes a plurality of storage locations such as an evidence data store configured to retain a collection of data related to a complex business problem faced by a sponsor of the game, wherein the collection of data includes media files conveying ethnographic information received from the sponsor, a scene information data store configured to store a collection of narrative scenes of the game, wherein each narrative scene includes a portion of a story and is associated with a portion of the collection of data, an interaction data store configured to store discussion threads; and a dossier data store configured to retain digital dossiers generated by players of the game. Further, the gaming platform can include a plurality of subsystems such as a browsing module configured to select items of evidence from the collection of data stored in the evidence data store, a scene navigation module configured to retrieve a narrative scene from the scene information data store in response to navigational input, a dossier module configured to manage and maintain the digital dossiers stored in the dossier data store, and a social interaction module configured to manage a discussion board via which players of the game can create discussion threads and participate in discussion threads. In yet another embodiment, the gaming platform can include a game builder module configured to generate the instance of the game based upon the ethnographic information and configuration information received from the sponsor.

Herein, an overview of some of the embodiments for an advisory services network and associated gaming platform have been presented above. As a roadmap for what follows next, an overview of exemplary, non-limiting embodiments and features of an advisory services network and/or an advisory services network gaming platform are described in more detail. Then, some non-limiting implementations and examples are given for additional illustration, followed by representative network and computing environments in which such embodiments and/or features can be implemented.

### Architectures of an Advisory Services Network

As mentioned above, in various embodiments, an advisory services network enables consulting services to be rendered to enterprise organizations facing complex problems. The advisory services network, however, is not limited to provision of consulting services to enterprise organizations can be employed for a variety of alternative purposes. For instance, the advisory services network can be employed to source a diverse crowd of people to gain perspective, identify issues, develop new innovation, or any other activity in which leveraging collective and individual experiences of a large group of people can generate fruitful results.

Further to the non-limiting example of the advisory services network as a consulting platform, the advisory service network, unlike conventional consulting business models, does not rely on a handful of senior consultants maintaining customer relationships while junior consultants handle problem solving. Accordingly, a large corporation, with diverse employees with expertise across numerous industries, can leverage the advisory services network to enter and compete in the consulting industry quickly and effectively without building a conventional large and costly consulting operation as described above. The advisory services network can, therefore, differentiate a consulting firm or a consulting division of a large corporation by employing a distinctive approach to providing solutions and building customer satisfaction through effective results.

The advisory services network provides immersion mechanisms through utilization of ethnography, capitalizes on a crowd sourcing to a diverse group and engages identified experts in a talent marketplace to develop quality solutions to enterprise organizations. The advisory services network implements several primary aspects. First, the advisory services network facilitates transforming the problem. Transforming the problem includes methodology to immerse experts in real-life case studies to identify with complex problems faced by enterprise organizations. For instance, transforming the problem can involve the use of ethnography (e.g., real-life interviews and observations) to obtain perspective on a culture, problems, and experiences of an enterprise organization. In addition, transforming the problem can involve various immersion tactics to place the consultants within the advisory services network in the place of the enterprise organization, e.g., walk in their shoes. Further, transforming the problem can include querying a crowd to expose uncover a core problem or identify other problems. The advisory services network can also facilitate crowd sourcing a solution, including methodology to utilize a large diverse group of individuals to solve complex problems. Finally, the advisory services network can implement a talent marketplace with methodology to leverage solution concepts and transform solution concepts into collaborative solutions.

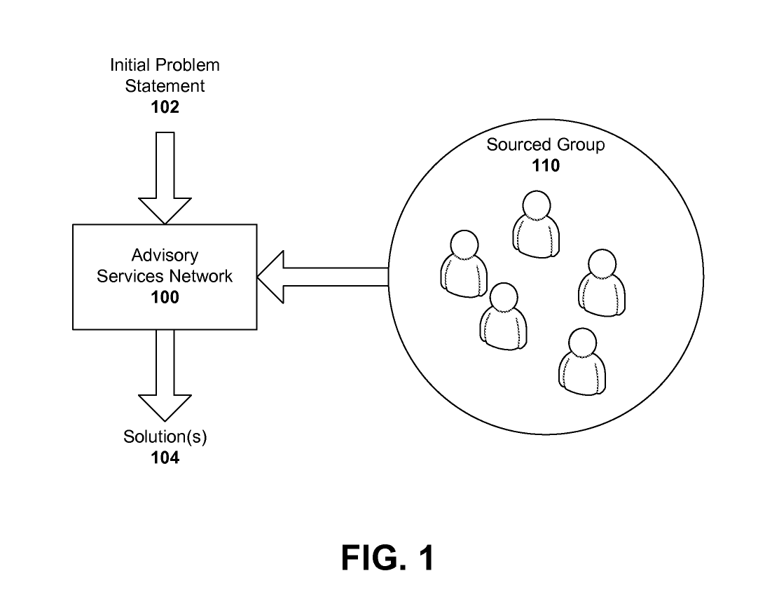

With respect to one or more non-limiting aspects of the advisory services network as described above, FIG. 1 shows a block diagram illustrating an exemplary, non-limiting embodiment for sourcing a group to develop solutions to complex problems. As shown in FIG. 1, an advisory services network 100 can receive an initial problem statement 102, which can establish a goal to achieve or a purpose of the advisory services network 100. In an example, an enterprise organization, a business, a governmental organization, or other similar entity experiencing a complex problem can supply initial problem statement 102, which attempts to portray the complex problem. In another example, the initial problem statement 102 can indicate a request to identify a problem of the enterprise organization, business, governmental organization, etc., based upon observed, undesired effects.

Advisory services network 100 draws upon sourced group 110 to generate and develop one or more solutions 104, which potentially solve the complex problem of the sponsor, e.g., the organization supplying initial problem statement 102. Sourced group 110 can include diverse group of experts, consultants, and other people. Diversity with sourced group 110 can exist in a variety of ways. For instance, members of sourced group 110 can exhibit diversity in terms of geography, culture, ethnicity, age, education, career, skills, background, experience, etc. Sourced group 110 can be built to achieve, intentionally, diversity in one or more characteristics. It is also to be appreciated that, as sourced group 110 grows in size, diversity in a variety of aspects inevitably occurs.

The advisory services network 100, in an aspect, increases exposure of a complex problem or goal embodied in the initial problem statement 102 to sourced group 110, which can be very large relative to a size of the sponsor supplying the initial problem statement 102. The sponsor can supply case studies depicting real-life scenarios, data, multiple views of problematic areas through ethnographic interviews, etc. to enables members of sourced group 110 to immerse themselves into the problem space. Advisory services network 100 facilitates, encourages, and manages creative discussions, among members of sourced group 110, regarding potential solutions. Advisory services network 100 challenges the conventional consulting services model which relies on knowledge of a handful of top consultants in a large consulting organization. Advisory services network 100 employs immersion techniques, crowd sourcing, and a talent marketplace to, respectively, convey extensive knowledge held by the sponsor regarding the problem space, leverage strengths and wisdom of a large diversified group, and surface great solutions and discuss the solutions with experts.

For instance, advisory services network 100 enhances solution building by identifying subject matter experts and enabling the subject matter experts to collaborate, co-innovate, and problem solve, in a virtual team environment. Subject matter experts, through advisory services network 100, can communication with one another, without being collocated, and leverage knowledge, skills, and experiences of the subject matter experts to solve complex problems and innovate further ideas. Accordingly, advisory services network 100 bridges geographical and cultural divides among experts and other members of sourced group 110 and brings them together in a virtual environment where sourced group 110 engage in discussions around complex problems and formulate solutions.

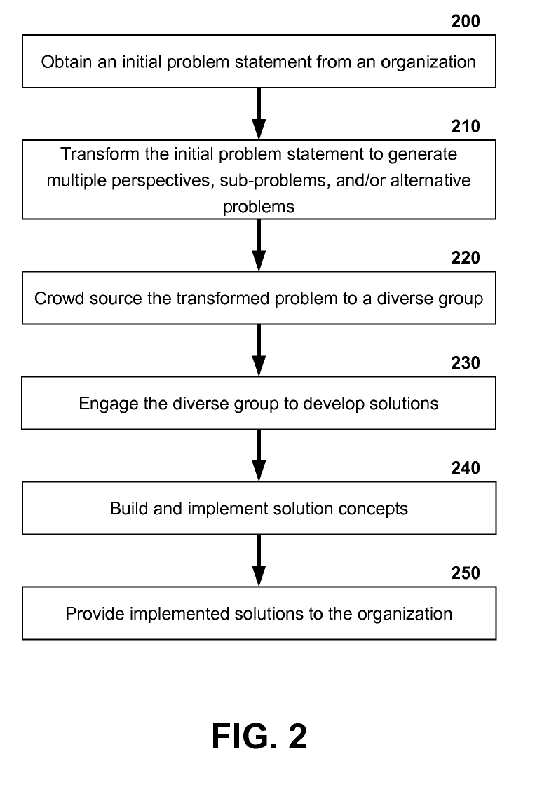

FIG. 2 depicts a flow diagram illustrating an exemplary, non-limiting embodiment for developing solutions to complex business problems via crowd sourcing. The embodiment shown in FIG. 2 can be utilized by advisory services network 100 of FIG. 1 to leverage sourced group 110 to develop solutions 104 based upon initial problem statement 102. At 200, an initial problem statement is obtained from an organization. The initial problem statement can convey an apparent problem faced by the organization. According to a non-limiting example, the apparent problem can be related to dataflow and information sharing limitations, capturing and transmitting real-time data, securing the right resources and equipment, brainstorming future innovations, etc.

At 210, the initial problem statement is transformed to generate multiple perspectives, sub-problems, and/or alternative problems. The problem can be transformed by a diverse group of participants in the advisory services network through direct observations, ethnographic interviews, support documents, etc., which capture various viewpoints of the initial problem statement from employees and associates of the organization. In addition, participants in the advisory services network can build dossiers to provide multiple perspectives or views of the problems faced by the organization, to articulate root problems of the organization, and/or to present focused opportunities for the organization in the future. During this phase, the participants immerse themselves in the problem space, review qualitative and quantitative data, and provide a wide variety of insights and perspectives as a result.

At 220, the transformed problem is crowd sourced to a diverse group. Crowd sourcing is a model that leverages collective insights and experience of the diverse group to produce quality results. Through crowd sourcing, the diverse group can work together to capitalize on strengths of the varied background, experiences, and individuality that each member of the diverse group. For instance, each member of the diverse group can offer a varied perspective on the transformed problem, and the diverse group, collectively or individually, can build upon the perspectives of others. The diverse group, harnessing multiple perspectives, can produce greater results than a homogenous group. During the crowd sourcing phase, members of the diverse group can, through advisory services network 100, offer solution, ideas, perspectives, build upon solutions, ideas, perspectives of others, and/or provide feedback on solutions, ideas, or perspectives.

At 230, the diverse group is engaged to develop solutions. In an aspect, engaging the diverse group occurs during crowd sourcing to encourage members of the diverse group to participate in crowd sourcing. In a specific, non-limiting example, a rewards-based model can be employed to entice members of the diverse group to participate and develop solution concepts.

At 240, solution concepts are built and implemented. For example, in the previous phases, subject matter experts can be identified in the diverse group. Virtual teams can be constructed around these subject matter experts. The virtual teams can collaborate to translate solution concepts, submitted by the diverse group sourced by the advisory service network, into solution designs and architectures. The organization can select one or more solution designs and architectures for implementation and deployment. At 250, implemented solutions are provided to the organization for deployment.

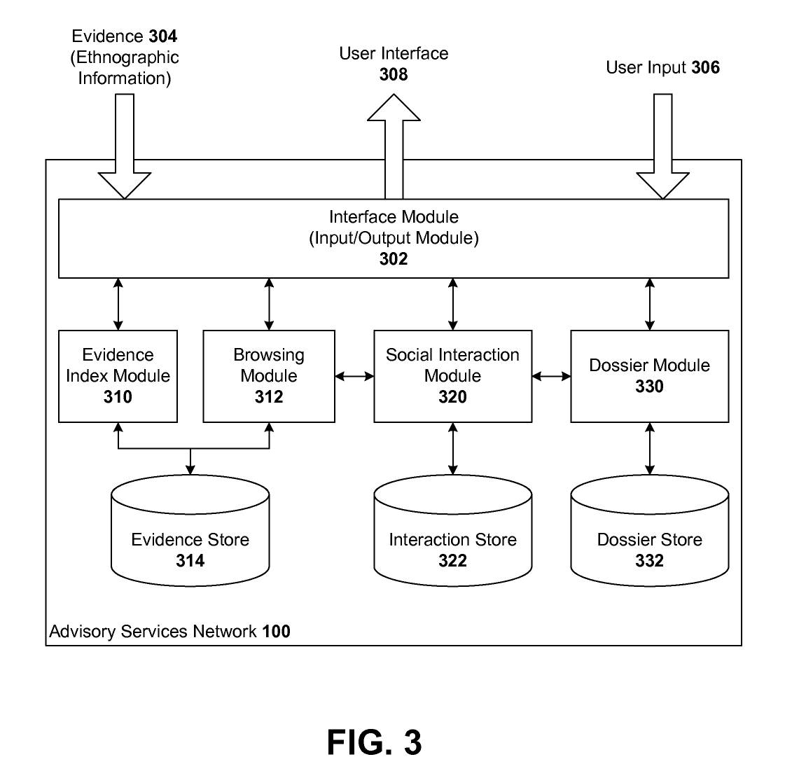

Turning to FIG. 3, illustrated is a exemplary, non-limiting advisory services network 300, implemented on a computing system, configured to effectuate transforming problems, crowd sourcing problems, generating solutions, engaging a diverse group, or other features of the advisory services network as described above with respect to FIGS. 1 and 2. Advisory services network 300, as shown in FIG. 3, can include an interface module 302 (also referred to as an input/output module). Interface module 302 can be configured to accept input from users, e.g., members of sourced groups, sponsors, etc., to coordinate handling of input among a variety of subsystems, and to provide generated output back to users. For example, interface module 302 can obtain evidence 304, which can include ethnographic information, a variety of media, documents, case studies, etc., related to a complex problem for which the advisory services network 300 is deployed to solve. Once obtained by interface module 302, evidence 304 can be indexed, e.g., organized, categorized, etc., by an evidence index module 310 and stored in an evidence store 314 of advisory services network 300. In an embodiment, advisory services network 300 obtains evidence 304 from a sponsor of advisory services network 300. According to an example, the sponsor can be organization with a complex problem that advisory services network 300 solves through crowd sourcing. The sponsor provides evidence 304 to convey a context of the complex problem and a deep understanding of the complex problem.

Interface module 302 further generates and maintains a user interface 308 configured to convey information to users and provide means for users to generate and send user input 306 to advisory services network 300. User input 306 can encompass a variety of requests, commands, or information to be handled by the advisory services network 300 and subsystems therein. For instance, user input 306 can include a request to view an item of evidence. Interface module 302, when the request to view the item of evidence is received, engages a browser module 312 which queries evidence store 314 to obtain the requested item of evidence. The obtained item of evidence can be forwarded to interface module 302 to be presented through user interface 308.

In another example, user input 306 can include a social interaction such as a command to create a discussion thread, a comment on a an existing discussion thread, a message sent to another user, a chat sent to another user, a linking of a media item to a discussion thread or comment on a discussion thread, a linking of a discussion thread to another discussion thread via a comment or other mechanism, or any other user action and content directed towards other users, interactions with media items, responses or interactions with previous social interactions, etc. Interface module 302 can utilize a social interaction module 320 to process the social interaction, generate metadata associated with the social interaction, record the social interaction and metadata in an interaction store 322, and/or modify metadata associated with previous social interactions, stored in interaction store 322, to indicate relationships formed as a result of the social interaction. Further, social interaction module 320 can direct interface module 302 to transmit a message to other users based upon the social interaction. For example, interface module 302 can send an e-mail message, an instant message, an SMS message, an MMS message, etc. to other users in response to the social interaction. For instance, the social interaction can be a comment on an existing discussion thread. In response, the interface module 302 can transmit a message to a user responsible for creating the discussion thread that the comment has been made. Further, the message can include the content of the comment as well.

In yet another embodiment, user input 306 can include a dossier command. A digital dossier (also referred to herein as a “dossier” or an “advisory services network dossier”), according to one aspect, is a mechanism of advisory services network 300 to encapsulate a perspective or view, of a complex problem, of a specific user from a diverse group of individuals participating in crowd sourcing via advisory services network 300. The dossier can capture a user's perspective which is influenced by the background, experiences, skills, etc. of the user. Accordingly, with a large and diverse group of users, the resultant set of dossiers provides a variety of viewpoints which facilitates articulation of root problems and launch pads for high-quality solutions to those root problems.

In a specific, non-limiting example, the dossier functions as a personal collection of evidence items built by a user of advisory services network 300. The user can review evidence items stored in evidence store 314 related to a complex problem and select specific items which the user believes represents the complex problem. The dossier enables the user to build a case on the complex problem by adding evidence to the dossier, removing evidence from the dossier, organizing evidence in the dossier, tagging evidence in the dossier, annotating evidence in the dossier, etc. The dossier can be shared with other user and/or experts also participating in advisory services network 300.

As shown in FIG. 3, advisory services network 300 includes a dossier module 330 which manages a set of dossiers stored in dossier store 332. In one embodiment, each user in the diverse group leveraged by advisory services network 300 to solve the problem can be associated with a respective dossier. Interface module 306, upon recognizing a dossier command in user input 306, can forward the command to dossier module 330 which is configured to modify a dossier stored in dossier store 332 in response to the dossier command.

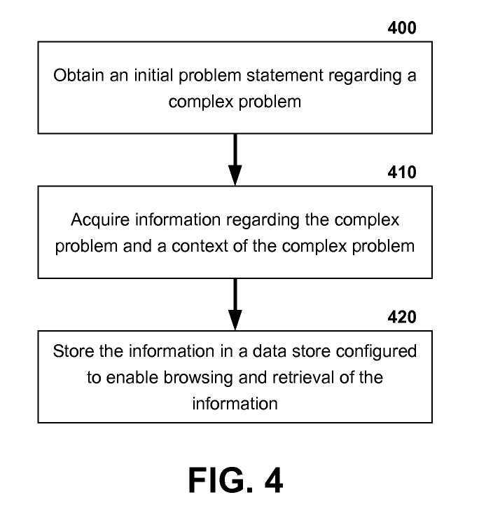

Turning to FIG. 4, illustrated is a is a flow diagram of an exemplary, non-limiting embodiment for populating an advisory services network with information related to a complex problem to facilitate problem solving. At 400, an initial problem statement, regarding a complex problem is obtained. The initial problem statement can convey an apparent problem of a sponsor of the advisory services network. At 410, information exhibiting the complex problem and explaining a context of the complex problem is acquired. The information can be ethnographic information, a variety of media (e.g., video, audio, etc.), documents, case studies, etc. At 420, the information acquired is stored in a data store (e.g., evidence store 314) configured to enable browsing and retrieval of the information.

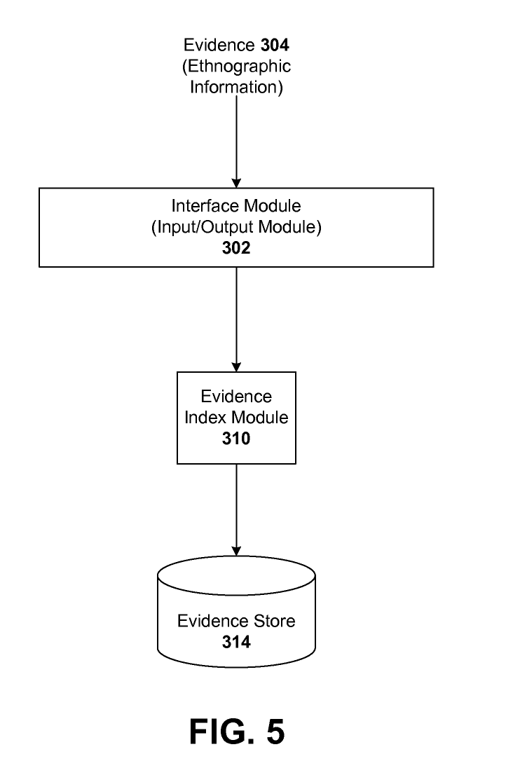

FIG. 5 is a block diagram illustrating an exemplary, non-limiting act of adding supporting evidence, related to a complex problem, to an advisory services network. According to an example, FIG. 5 illustrates the method described above with reference to FIG. 4. As shown in FIG. 5, evidence 304, which can include ethnographic information as well as a variety of media of various types, is input to the advisory services network via interface module 302. Evidence 304 is forwarded to evidence index module 310 for indexing, categorization, organization, etc. and stored in evidence store 314.

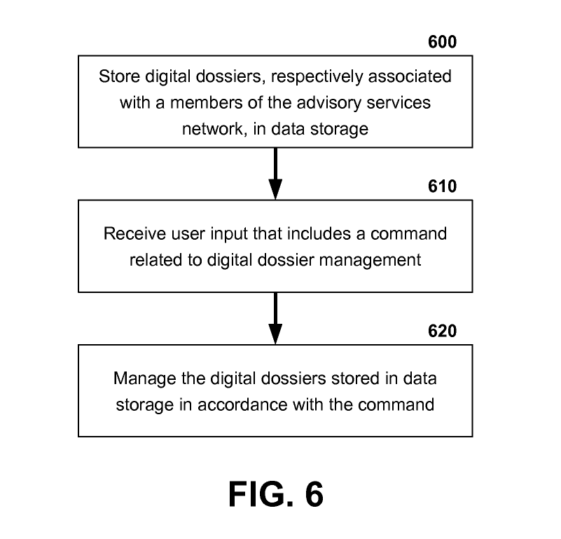

FIG. 6 illustrates a flow diagram of an exemplary, non-limiting embodiment for enabling a digital dossier within an advisory services network. At 600, digital dossiers, respectively associated with members of an advisory services network, e.g., advisory services network 100 or advisory services network 300, are stored in data storage, e.g., dossier store 332. At 610, user input is received from a user, wherein the user input includes a dossier command. The dossier command can be a command to add a data item (e.g., an item of evidence stored in evidence store 314) to a dossier corresponding the user, to remove an item from the dossier, to organize or reorder items in the dossier, to incorporate notes, tags, groups, or other metadata to items of the dossier, to publish the dossier to expose the dossier for review by other users, to start a discussion regarding the dossier, or any other command related to management of the dossier. At 620, the dossier, stored in data storage, is managed, e.g., modified, updated, etc., in accordance with the dossier command included in the user input received.

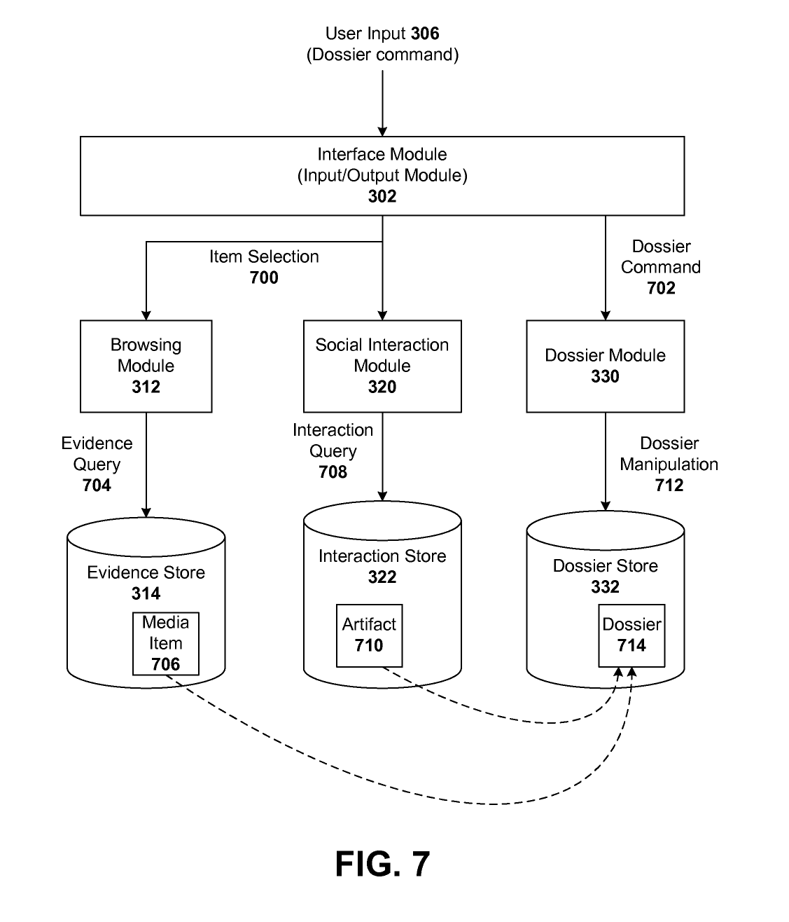

FIG. 7 is a block diagram illustrating an exemplary, non-limiting act of managing a digital dossier of an advisory services network. According to an example, FIG. 7 illustrates the method described above, with reference to FIG. 5, in terms of advisory services network 300 introduced in FIG. 3. As shown in FIG. 7, user input 306, which can include a dossier command, is input to the advisory services network via interface module 302. As dossier management can involve adding data items such as media items, e.g. evidence, or interaction artifacts representing previous social interaction or a set of social interactions, interface module 302 engages multiple subsystems when handling the dossier command. In a specific, non-limiting example of a dossier command to add a data item or a set of data items to a dossier, interface module 302, based upon the dossier command included in user input 306, can initiate an item selection 700 with browser module 312 and/or social interaction module 320. For instance, the dossier command can specify a media item 706, stored in evidence store 314, or an interaction artifact 710, stored in interaction store 322, which is to be added to dossier 714, corresponding to a user issuing the dossier command and stored in dossier store 332. In another aspect, the dossier command can be a group add command such that a group of items are selected and added to the dossier at the same time. For example, artifact 710 can represent a social interaction related to media item 706. The dossier command can identify both the social interaction, represented by artifact 710, and media item 706 for inclusion in dossier 714.

In response to item selection 700 from interface module 302, browser module 312 and social interaction module 320 respectively issue queries. Particularly, browser module 312 sends evidence query 704 to evidence store 314 and social interaction module 320 transmits interaction query 708 to interaction store 322. In response to evidence query 704, evidence store 314 obtains media item 706, which can be returned to browser module 312 and/or interface module 302. Media item 706 can be retrieved and returned as either a copy or a reference. Similarly, interaction store 322 can retrieve artifact 710 in response to interaction query 708 and forward artifact 710, as a copy or reference, to either social interaction module 320 or interface module 302.

The retrieved copies or references of media item 706 and/or artifact 710 can be provided to dossier module 330 along with dossier command 702 (e.g., an add command according to an example) extracted from user input 306. Dossier module 330, in accordance with dossier command 702, can modify dossier 714 to include the retrieved media item 706 and/or artifact 710. In one embodiment, dossier module 330 can modify a data structure which implements dossier 714 to include the copy of media item 706 and/or artifact 710. In an alternative embodiment, dossier module 330 incorporates references, e.g., links, shortcuts, aliases, etc., to media item 706 and/or artifact 710 into the data structure of dossier 714.

According to another example, the dossier command 702 can be a publish command that exposes dossier 714 for review by other users. For instance, the publish command can create a discussion thread, on a discussion board or forum provided and managed by the social interaction module 320, for commenting on dossier 714. Further this example, dossier module 330, when responding to the command, can retrieve a copy or a reference of dossier 714 from dossier store 332, and the copy or reference to social interaction module 320, which can create a discussion thread around dossier 714.

In yet another example, dossier module 330 can execute dossier command 702 included in user input 306 without engaging other subsystems such as browsing module 312 or social interaction module 320. For instance, a removal command, a metadata edit command (e.g., a tagging command, a grouping command, etc.), an ordering command, or the like, can be individually carry out dossier command in user input 306.

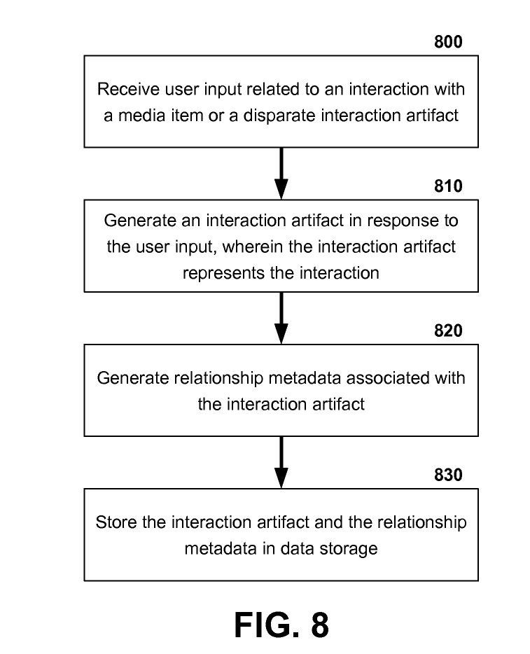

FIG. 8 illustrates a flow diagram of an exemplary, non-limiting embodiment for managing social interactions among a plurality of participants of an advisory services network. At 800, user input is received, wherein the user input relates to an interaction, e.g., a social interaction, which can be an originating social interaction (e.g., starting a discussion thread on a discussion forum, initiating a chat, transmitting a message, etc.), a social interaction related to a media item (e.g., attaching a media item or evidence to a ongoing discussion thread, starting a discussion thread about a particular media item, attaching a discussion thread to a media item, etc), or a social interaction related to previous interaction artifact (e.g., a comment on an existing discussion thread, a response to message, etc.). At 810, an interaction artifact is generated in response to the user input. The interaction artifact can be a data structure that represents the social interaction and contains information regarding the social interaction specified in user input. At 820, relationship metadata associated with the generated interaction artifact is created. Relationship metadata links the generated artifact to one or more media items, e.g., evidence, disparate artifacts generated from previous social interactions input to the advisory services network, dossiers of one or more users, etc. For instance, a social interaction can be a discussion thread started around a particular evidence or media item, a response to a social interaction made previously, a comment on a dossier of a user, etc. The relationship metadata can specify this relatedness so that a record of links, formed by users via social interaction, between discussions, media items, dossiers, etc., can be built to facilitate discovery of patterns, issues, solutions, or the like. At 830, the interaction artifact and the relationship metadata generated is stored in data storage, such as interaction store 322.

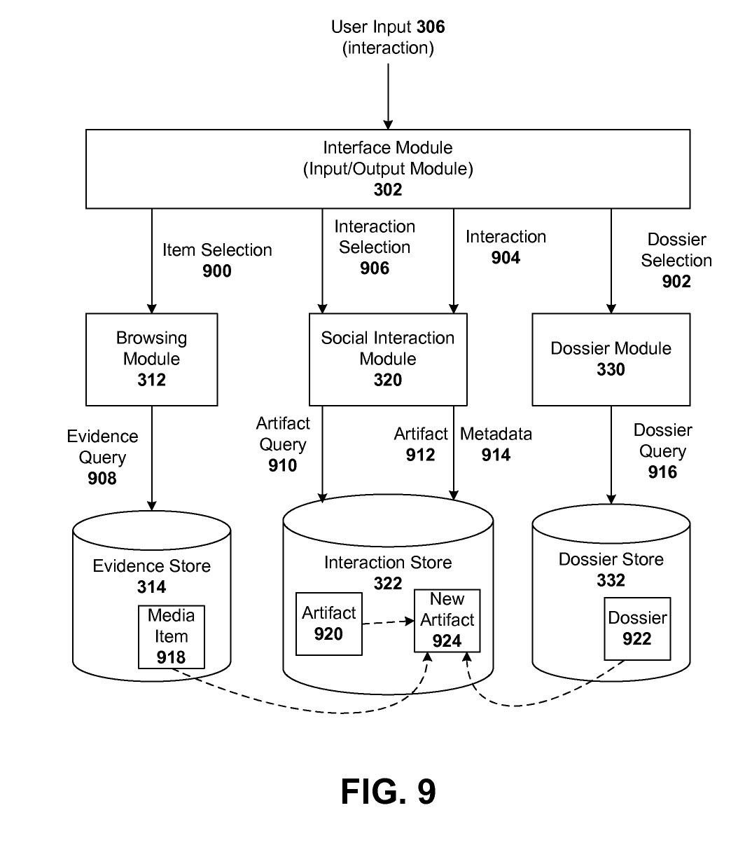

FIG. 9 is a block diagram of an exemplary, non-limiting act of maintaining and representing social interactions among participants of an advisory services network. According to an example, FIG. 9 illustrates the method described above, with reference to FIG. 8, in terms of advisory services network 300 introduced in FIG. 3. As shown in FIG. 9, user input 306, which can include an interaction, is input to the advisory services network via interface module 302. As social interaction features provided to users by advisory services network 300 can involve interactions of users with a variety of data items as media items, e.g. evidence, dossiers, or interaction artifacts representing previous social interactions or a set of social interactions, interface module 302 engages multiple subsystems when handling the social interaction. By way of example, social interactions supported by advisory services network 300 can include a plurality of communicative aspects (e.g., discussion forums, chat messaging, e-mail messaging, text messaging, video chat, audio chat (VoIP), etc.), or user interactions with data stored and managed by advisory services network 300, (e.g., interactions with evidence or media items, interactions with dossiers of other users, interactions with other interactions, etc.).

As shown in FIG. 9, when the interaction included in user input 306 relates to an item of evidence, interface module 302 issues an item selection 900 to browsing module 312, wherein the item selection 900 specifies an item of evidence stored in evidence store 314 which is desired (e.g., the interaction in user input 306 references the item of evidence). The browsing module 312 sends an evidence query 908 to evidence store 314 to obtain media item 918, which evidence store 314 can return to browsing module 312 and/or other recipients such as interface module 302 or social interaction module 320. Similarly, when the interaction in user input 306 specifies a dossier, interface module 302 performs a dossier selection 902 with dossier module 330. Dossier module 330 issues a dossier query 916 to dossier store 332 to retrieve dossier 922. Dossier store 332 provides dossier 922 to dossier module 330 in response to dossier query 916. Dossier 922 can also be provided to interface module 302 or social interaction module 320 via dossier module 330 or directly by dossier store 332. In a further example, where the interaction specified in user input 306 relates to a previous social interaction input to advisory services network 300, an interaction selection 906 is sent from interface module 302 to social interaction module 320. When executed interaction selection 906, social interaction module 320 sends an artifact query 910 to interaction store 322 to obtain artifact 920.

As discussed above, interactions can be related to, in response to, or regarding media items, dossiers, or previous social interactions. Accordingly, referenced media items, dossiers, or previous social interactions are retrieved as described above to enable social interaction module 320 to generate artifact 912 and metadata 914 from interaction 904 extracted from user input 306 by interface module 302. Artifact 912 represents interaction 904 and, additionally, records the content of interaction 904. Metadata 914 can specify a type of interaction of 904, data items related to interaction 904 such as data items, e.g., evidence, dossiers, other social interactions, referenced by interaction 904 or for which interaction is created around. For instance, media item 918 can be an item of evidence which, while a user is viewing media item 918, provides user input 306 to create a discussion thread with a topic regarding media item 918. In the foregoing example, the action to create a discussion thread and the creation of the discussion thread are encapsulated into interaction 904 and artifact 912 generated by social interaction module 320 represents the discussion thread and retains the content, e.g., thread topic title, starting comment, etc., of the newly created discussion thread. Moreover, metadata 914 can indicate the linking relationship between media item 918 and the discussion thread encapsulated by artifact 912. As shown in FIG. 9, artifact 912 and metadata 914 generated by social interaction module 320 can be stored in interaction store 322 as artifact 924.

In an further embodiment, advisory services network 300 and subsystems implemented by browsing module 312, social interaction module 320, and dossier module 330 enable users, e.g., members of a diverse group such as a employees of a large multi-national corporation, to review a wide array of media types related to a complex problem, start discussion about content, develop a case file on the complex problem, etc., from within the media itself (e.g., while viewing the media through a user interface). Multiple forms of media can be added to new or on-going discussion threads to add additional insight into the social commentary. With advisory services network 300, users, while viewing evidence (media items) on user interface 308 with commands executed by browsing module 312, can be prompted to start a discussion or multiple discussions about the evidence, via a social interactions managed by social interaction module 320. In addition, users of advisory services network 300 can, when reviewing, via social interaction module 320, existing discussion threads, stored by interaction store 322, can identify disparate media items from evidence store 314 to on-going discussions, whereby, in addition to generating a new artifact in interaction store 322, new metadata is generated to indicate the relationship between the disparate media items and the on-going discussions.

Advisory services network 300, in an aspect, provides a platform, and the various mechanisms described above, to people from varied background and cultures to view volumes of information and media related to a complex problem and select the items to share with other people via discussions or dossiers. The advisory services network 300 and associated subsystems enable gathering of pieces of evidence, formation of discussion around the evidence, and/or a change evidence coupled to a discussion (e.g., addition of evidence, removal of evidence, etc.). Thus, advisory services network 300 enables different media types to be connected through social interactions, e.g., discussions, through which centralized patterns or themes can emerge. In other words, advisory services network 300 enables users to add commentary on different media types and/or start discussions and facilitates engaging users to continue to review, analyze, and form various perspectives regarding the media, e.g., evidence.

As described above, advisory services network 300 can store massive amounts of media (evidence) which can be reviewed, referenced, discussed, and joined to other media to build up cases of evidence (dossiers), to facilitate solution building. For example, multiple media types such as, but not limited to, audio, video, documents, images, graphics, podcasts, message boards, hyperlinks, dossiers, discussion comments, text messages, etc., can be stored and made available for viewing by users. In addition, advisory services network enables users to review cases by reviewing dossiers or reviewing overall discussion threads. Further, users can drill into the linked media. For instance, advisory services network 300, through social interaction module 320 and interaction store 322, can host on-going discussions about evidence in evidence store 314 or dossiers in dossier store 332. By way of example, advisory services network 300 can attach comments or tags input by a user to a single media item or multiple media items; create a single discussion thread or a multiple discussion threads from one or more media items selected by a user; merge, morph, evolve, expand, or link disparate discussion threads with media items selected by a user or directly from user input; facilitate identification of unifying themes, commonalities, patterns through construction and visualization of large webs of discussion threads on multiple media sources as well as web of links between discussion thread and media sources. Moreover, advisory services network 300 and, specifically, dossier module 330 enables users to build cases of evidence, e.g., dossiers, by joining like or unlike media items with related or unrelated content together in dossiers to generate new perspectives, greater insight into the complex problem, and analysis of the complex problem.

According to an exemplary, non-limiting analogy, linking of media items or evidence through social interactions (e.g., discussions) can be compared to a baby crib mobile. For instance, from a top most discussion thread, different pieces of evidence and other discussions can hang together or be joined together by a common theme. Accordingly, a user can enter the advisory service network 300 at a later time, after many discussions have been created, and still be able to follow the general trends, lines of thought, and understand current perspectives, and review associated evidence items to derive new conclusions. Thus, the advisory services network 300 enables users to contribute at many stages and at different times.

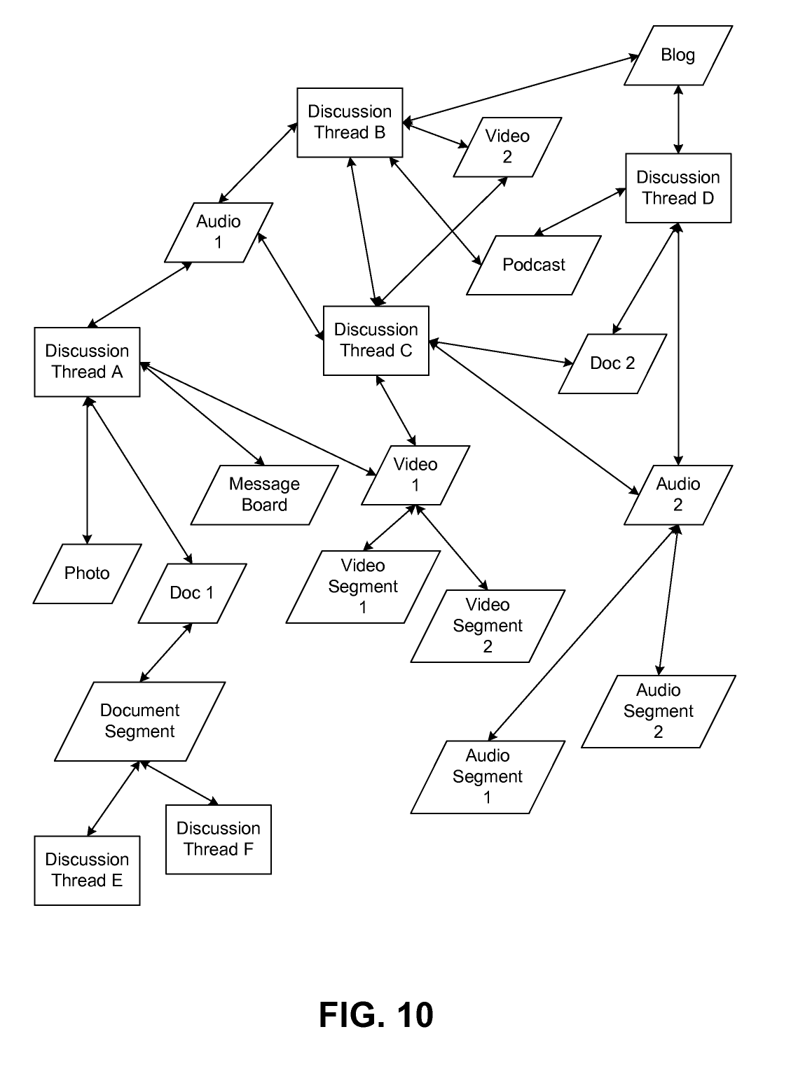

FIG. 10 depicts an exemplary, non-limiting web of discussion threads and media item (e.g., evidence) linked together via social interactions as described above. As shown in FIG. 10, various media types (e.g., video, audio, podcasts, message boards, documents, blogs, etc.) can be interlinked with discussion threads created, for example, by users of the advisory services network. The web of media items and discussion threads enable collections of items to be formed around a common theme. The linkings between items and discussion threads can be formed through social interactions based around the media types as described above.

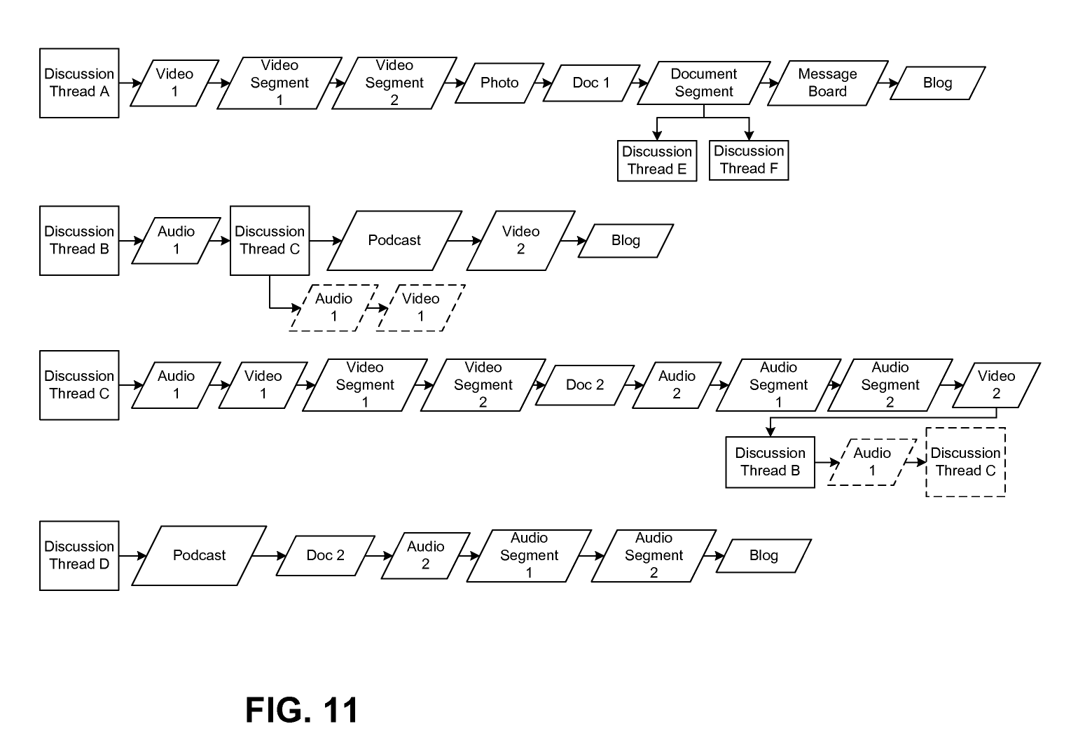

FIG. 11 illustrates exemplary, non-limiting variations on how discussions can link to multiple media types and other discussions. Particularly, FIG. 11 depicts various media types hanging from discussions and how, through these media types hanging from discussions, various relationships between disparate discussions can become apparent. For instance, as shown in FIG. 11, Discussion Thread B and Discussion Thread C, and respective media items tied thereto, intersect. Such intersections can be indicative of a prevailing pattern.

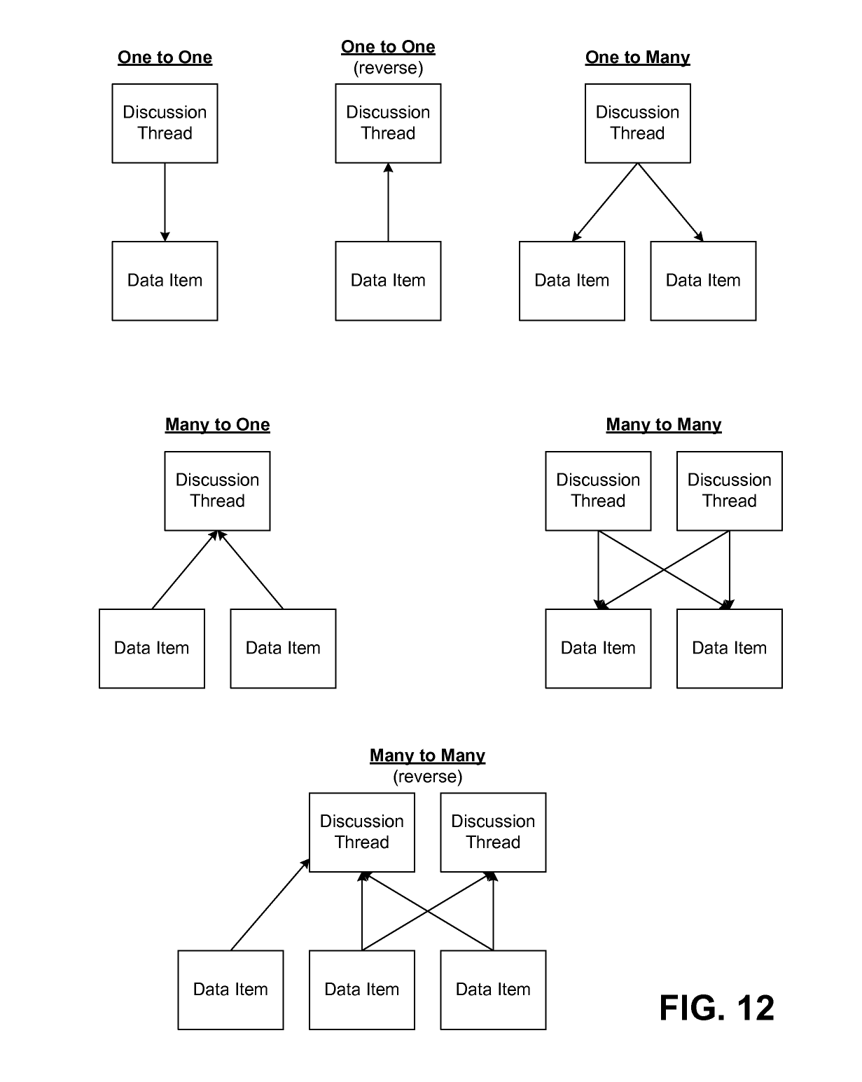

FIG. 12 illustrates exemplary, non-limiting relationships between media types in accordance with one or more embodiments. In one example, FIG. 12 shows a one-to-one relationship between a discussion thread and a data item both in a forward direction and a reverse direction. A forward direction can indicate the discussion thread referencing the data item (e.g., the discussion thread is created from or links to the data item). A reverse direction indicates the data item being added to or incorporated into the discussion thread. Also shown in FIG. 12 are a one-to-many relationship and a many-to-one relationship (e.g., one-to-many in reverse), wherein multiple data items are referenced by or incorporated into a discussion thread. Not shown in FIG. 12, but appreciated from the foregoing, are inverse relationships where multiple discussion threads reference a single data item and/or a single data item is incorporated into multiple discussion threads. Extending further, as shown in FIG. 12, many-to-many relationships are possible wherein multiple discussion threads reference multiple data item (forward direction) or multiple data item are incorporated into multiple discussion threads (reverse direction).

The aforementioned embodiments of an advisory service network provide a general architecture and platform through which to provide consulting services. Described below is an associated gaming platform which provides a potential environment in which to implement the aforementioned embodiments as well as further embodiments detailed below.

### Architecture of a Gaming Platform of the Advisory Services Network

In a specific, non-limiting embodiment, the advisory services network can be implemented as a gaming platform to coordinate transforming the problem, crowd sourcing problem solving, and engaging experienced talent to develop real world solutions. A serious game, e.g., a game with a primary objective to be fun and educational, can be developed on the gaming platform. The game can be based around one or more complex problems plaguing an enterprise organization. In particular, the developed game can include a back story, a plurality of narratives, and evidence (e.g., videos, graphics, documents, data, etc.).

The game immerses players (e.g., members of a diverse source group of the advisory services network) into the problem space of the enterprise organization. The game challenges players to identify real problems from apparent problems and develop possible solution to the real problems. The game encourages players to share ideas with other players who can provide fresh perspectives and additional input based upon their own, individual findings. As the game pushes more and more players to offer viewpoints and solutions concepts, the game provides mechanisms to enable players to interact, exchange ideas, and discuss ideas. In this manner, the players can modify their own ideas based upon the viewpoints of other players, collaborate together on solutions, and otherwise uncover high quality and robust solutions via perspective compounding.

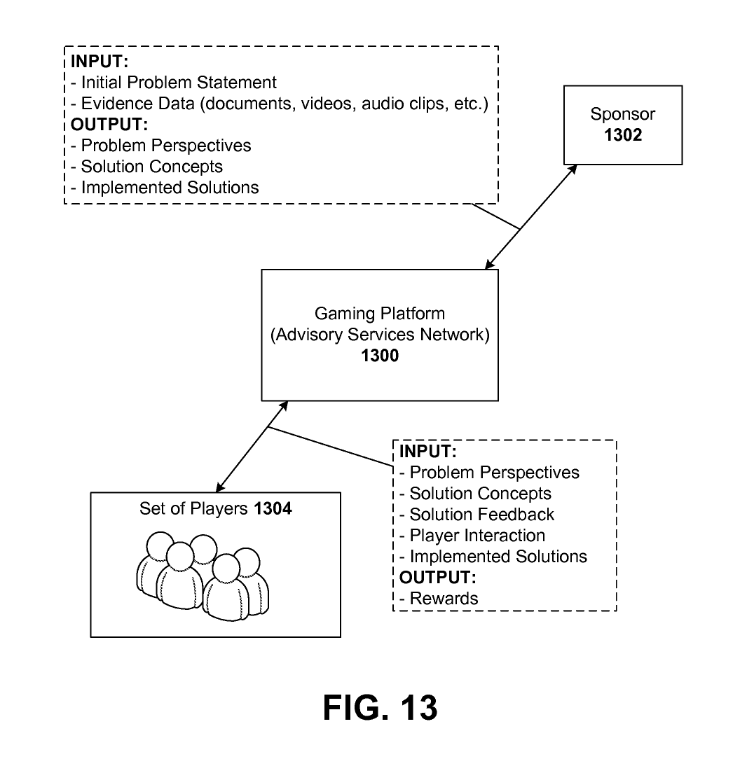

Turning to FIG. 13, a block diagram is shown illustrating an exemplary, non-limiting embodiment for a gaming environment which immerses players in problems faced by an organization. As shown in FIG. 13, a gaming platform 1300, implementing the advisory services network, on which a serious game can be designed, implemented, and deployed. The serious game, as mentioned above in the Overview, can provide an entertaining and thought provoking environment in which at least a portion of the processes and embodiments described above with respect to FIGS. 1-12 can occur. For instance, the serious game can be designed to facilitate solving real-world complex business problems and challenges faced by an organization, such as sponsor 1302. The serious game of gaming platform 1300 is configured to immerse a set of players 1304 into the business of sponsor 1302, to engage and reward the set of players 1304 for solution building, and to promote interaction, collaboration, and discussion among the set of players 1304.

As illustrated in FIG. 13, gaming platform 1300 obtains various inputs from sponsor 1302 and/or the set of players 1304. In addition, gaming platform 1300 provides various outputs to sponsor 1302 and the set of players 1304. For instance, sponsor 1302 can supply gaming platform 1300 with an initial problem statement specifying an apparent problem and evidence such as videos, audio clips, documents, etc., which further detail the apparent problem. The gaming platform 1300 employs the initial problem statement and evidence to establish a setting (e.g., introduction and narrative game content) of the serious game corresponding to the complex problems suffered by sponsor 1302. The setting provides a story in which the evidence fits while also supporting the evidence.

The set of players 1304, via the established setting, carry out the steps of the advisory services network process described in FIGS. 2, 4, 6, and 8. For instance, the set of players 1304 can provide input to the game in the form of problem perspectives (e.g., description of each player's view of the problems of sponsor 1302), solution concepts, feedback on solution concepts of other players, interactions and discussions among players, implemented solutions, and the like. Through gaming platform 1300, sponsor 1302 is presented with the problem perspectives, solution concepts, and implemented solutions developed by the set of players 1304. In return, the set of players 1304 achieve rewards. It is to be appreciated that the inputs and outputs illustrated in FIG. 13 are several examples to facilitate understanding of the gaming platform 1300 and are a non-exhaustive listing of the inputs and outputs which can expressed in the gaming platform 1300.

Gaming platform 1300 implements an attraction magnet, a high fidelity context transmission system, and a perspective compounding system to generate a problem-solving environment within a context of a serious game. For instance, the attraction magnet encourages the set of players 1304 to participate in the game, the high fidelity context transmission system enables the set of players 1304 to immerse themselves in the problems of sponsor 1302 (e.g., walk a mile in their shoes) through storytelling which enables the set of players 1304 to marinate in the story and context. Storytelling, in an aspect, transmits a context more efficiently than numbers and other analytical data surrounding the complex problems of sponsor 1302. Once immersed in the complex problem, the set of players 1304 can problem-solve through joint discussions and perspective compounding.

In an embodiment, the attraction magnet is a technique to entice players to want to enroll in the game, continue to play, and return frequently. The attraction magnet can be implemented by creating a fun and interactive gaming environment, establishing a game objective to solve real-world complex problems to provide a sense of accomplishment, providing a rewards-based system, facilitate building reputations among players. For instance, a combination of internal and external motivations can be implemented to provide the attraction magnet. Internal motivations seek to reward players based upon intrinsic value systems held by the players. Some players would not contribute without intrinsic value. Gaming platform 1300 enables players to engage anonymously and build up a reputation, which makes gaming platform 1300 evocative. The internal rewards systems implemented by gaming platform 1300 awards points to the players for actions, which allow players to grow reputations and gain notoriety from peers and co-workers. External motivations can involve sponsor 1302 or a host or operator of gaming platform 1300 providing prizes to players.

In a further embodiment, the high fidelity context transmission system is a process to transmit data from one person to another while minimizing a loss of context. For instance, gaming platform 1300 employs ethnographic techniques to capture video and data from sponsor 1302 regarding a culture, customs, beliefs, and behavior of sponsor 1302. Immersions techniques such as storytelling coupled with viewing interviews, images, documents, data, etc., enables the set of players 1304 to comprehend the problem space of sponsor 1302. Integrity of data modification is preserved by uncovering important information via ethnographic techniques without losing contextual data during capture and transmission to gaming platform 1300. Gaming platform 1300 enables storytelling through narrative scenes and viewing of rich media, e.g., audio, video, etc., captured from sponsor 1302 via ethnographic techniques, thus preserving the data and transmitting the data to the players with little modification while also transmitting context along with the information.

Gaming platform 1300, in another embodiment, enables perspective compounding by allowing players to form a perspective and, subsequently, form new perspectives around perspectives of other players. Perspective compounding can be implemented by a discussion board system and dossier system that encourages open discussions about ideas, encourages players to generate ideas together and form new ideas based on everyone's perspectives, and advances problem-solving through a collaborative approach. Specifically, as described in more detail herein, gaming platform 1300 includes a dossier system wherein players can independently put together case files (e.g., dossiers) based upon evidence stored by gaming platform 1300. The individual dossiers express individual points of view of the players on the complex problem. Dossiers can be exposed and discussion via discussion threads to enable perspectives to be shared and built upon. Sharing of perspectives can influence perspectives of players and compound to facilitate generation of optimal solutions to the complex problem.

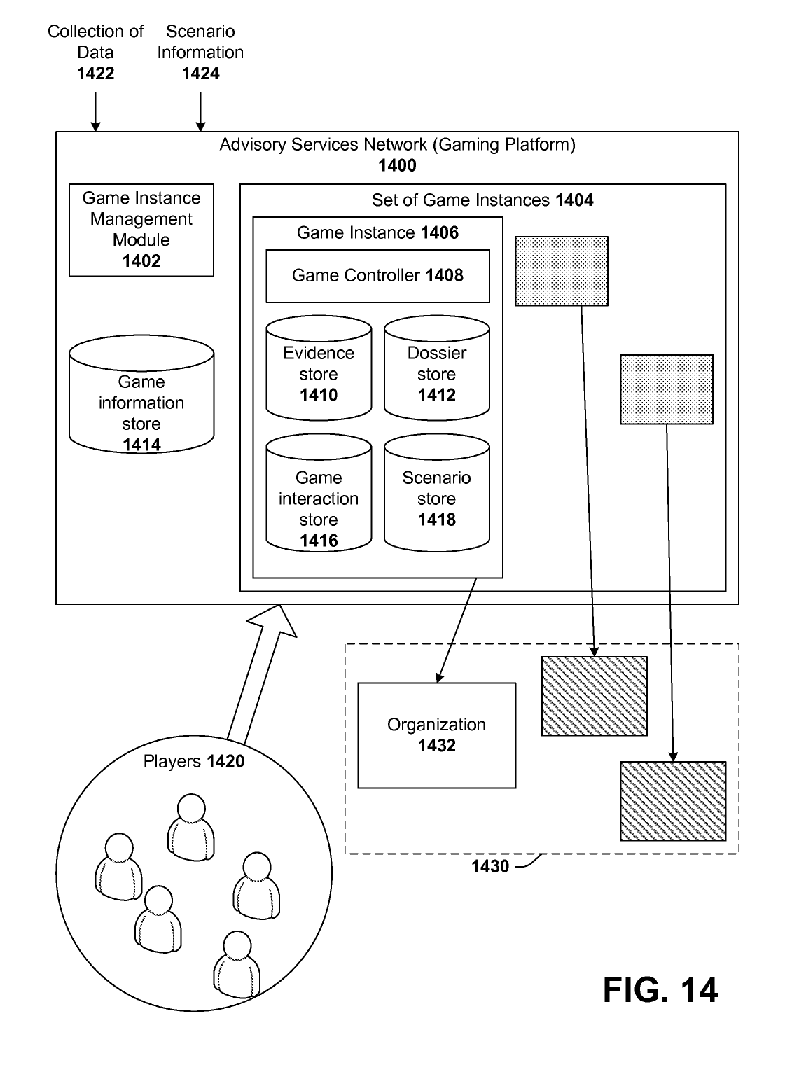

Turning to FIG. 14, illustrated is a block diagram of an exemplary, non-limiting embodiment of advisory services network 1400 or gaming platform configured to host a plurality of serious game instances. As shown in FIG. 14, the advisory services network 1400 hosts a set of game instances 1404, where each game instance is a playable serious game. While FIG. 14 depicts the set of game instances 1404 having three game instances, it is to be appreciated that FIG. 14 is an exemplary embodiment to illustrate one or more aspects of the advisory service network 1400 and that the set of game instances 1404 hosted by the advisory service network 1400 can include up to N game instances, where N is an integer greater than or equal to one.

Advisory service network 1400 can include a game instance management module 1402 configured to administer the set of game instances 1404. According to a specific, non-limiting example, the game instance management module 1402 can instantiate new game instances. The game instance management module 1402 can generate a new game instance from received information provided by a sponsor of the new game instance (e.g., an organization with a complex problem) or developed, by a provider of the advisory services network, based upon information obtained from the sponsor. Specifically, game instance management module 1402 creates game instance 1406 based upon a collection of data 1422 and scenario information 1424 provided to the advisory services network 1400. The collection of data 1422 can include various items of evidence, e.g., photos, videos, audio clips, documents, etc., which support or explain aspects of a complex problem providing the setting of game instance 1406. Scenario information 1424 can include a series of narratives divided into scenes which organize the collection of data 1422 in a meaningful manner to provide a player with a fun and thought-provoking journey through the complex problem of game instance 1406. Scenario information 1424 can be created so as to immerse players 1420 in the world of the sponsor of game instance 1406 while playing the game.

Game instance management module 1402 instantiates game instance 1406 and populates various data stores therein with data based upon the collection of data 1422 and the scenario information 1424. The instantiated game instance 1406 can be a data structure which is populated by the collection of data 1422 and scenario information 1424 and stored in game information store 1414 along with other game instances created. In a specific example, when creating game instance 1406, game instance management module 1402 can store the collection of data 1422 into an evidence store 1410 of game instance 1406. In addition, game instance management module 1402 can save scenario information 1424 into a scenario store 1418. Further, game instance management module 1402 configures a game controller 1408, which maintains a user interface for players 1420, handles input from players 1420, progresses game play in accordance with scenario information stored in the scenario store 1418, manages access and storage of data to the various data stores of game instance 1406, and performs a variety of other functions. As players 1420 engage the serious game provided by game instance 1406, game controller 1408 appropriately responds. As described above, players 1420 can navigate through scenes and narratives, view supporting evidence, and select items of evidence to be added to dossiers respectively associated with the players 1420. Game controller 1408 receives navigation input from players 1420, retrieves requested scene information from scenario store 1418, and generates a corresponding user interface presented to players 1420. Moreover, game controller 1408 can receive the evidence selection and update dossier information in a dossier store 1412 appropriately.

As described above, an aspect of serious games provided by advisory service network 1400 is the ability of players 1420 to suggest, develop, collaborate, etc. on solutions to the complex problem of the sponsor via social interactions. As players 1420 collaborate to generate solutions and/or solution concepts, game controller 1408 retains the social interactions (e.g., discussions, evidence linkings, messages, etc.) in a game interaction store 1416. While FIG. 14 depicts the various data stores as distinct elements, it is appreciated that such separation is a functional separation intended to facilitate comprehension of one or more features of serious games hosted by the advisory services network 1400. It is to be appreciated that single data store, with or without partitions, can be employed to store various game, evidentiary, and player-generated information.

As shown in FIG. 14, each game instance in the set of game instances 1404 can be associated with a sponsor, such as an organization with a complex problem, from a set of organizations 1430. In a specific, non-limiting example, game instance 1406 corresponds to organization 1432. Accordingly, the collection of data 1422 and scenario information 1424 employed to generate game instance 1406 can originate from organization 1432 and can relate to a complex business problem of organization 1432. While FIG. 14 shows game instances in the set of game instances 1404 individually and respectively associated with distinct organizations in the set of organizations 1430, it is to be appreciated that a single organization can sponsor multiple game instances corresponding to multiple complex business problems, or multiple organizations can sponsor a single game instance related to a shared complex problem.

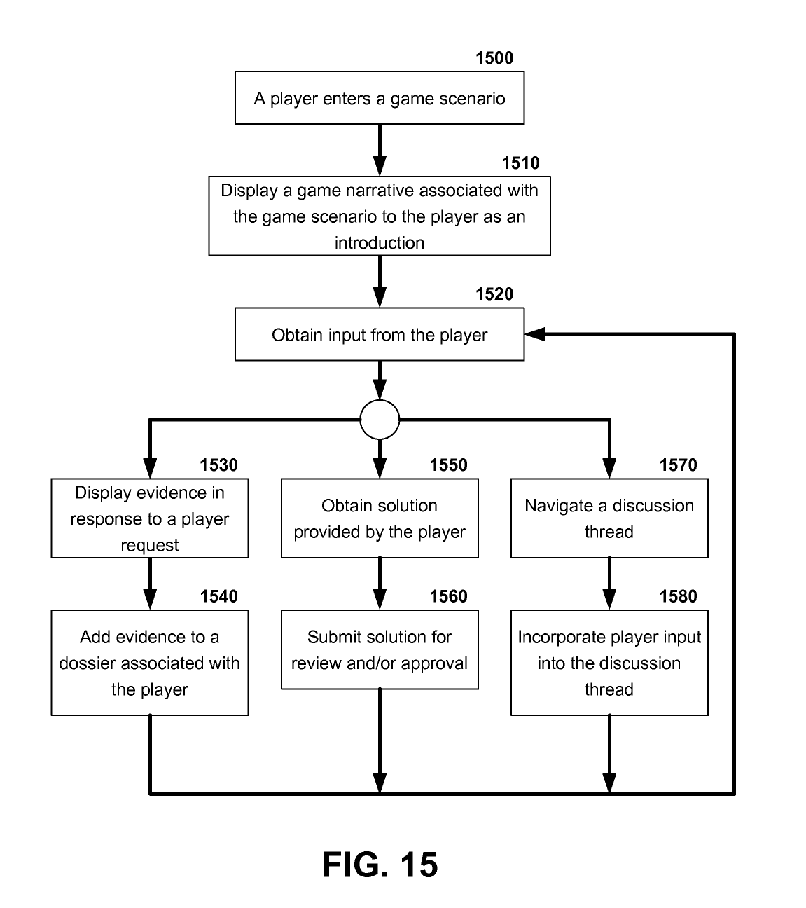

FIG. 15 shows a flow diagram illustrating an exemplary, non-limiting embodiment for a gaming environment which immerses players in a business of an enterprise organization facing a complex business problem. The embodiment depicted in FIG. 15 is one example of a workflow followed by the set of players 1304 of a serious game of gaming platform 1300 from FIG. 13. At 1500, a player enters a game scenario. At 1510, a game narrative association with the game scenario is displayed to the player as an introduction. The narrative, according to an exemplary embodiment, can include a plurality of scenes each portraying a portion of a larger story specifying a complex problem. After reading through the game narrative, the player can begin interacting with the game. Accordingly, at 1520, input is obtained from the player. The input provided by the player can take several forms or indicate one of several actions desired by the player. In one example, the input can be a selection of an item of evidence associated with a particular scene of the narrative. In response to this input, at 1530, the selected item of evidence is displayed to the player. At 1540, the selected item of evidence is added to a dossier associated with the player.

In another example, the input can be a solution or a solution concept developed by the player. At 1550, the solution or solution concept, provided by the player, is obtained. At 1560, the solution or solution concept is submitted for review and/or approval by, for example, an organization whose complex problem is modeled within the game. In yet another example, the input can be navigational input to transition the user to a discussion thread hosted within the game. At 1570, in response to navigational input obtained from the player, the discussion thread can be retrieved and displayed. The player can read, respond, collaborate, or otherwise participate in the discussion thread. At 1580, player input (e.g., posts, etc.) can be incorporated into the discussion thread.

While FIG. 15 depicts individual input handling paths, it is to be appreciated that such depiction is a simplification to provide a high level overview of potential actions, scenarios, and responses within a game instance of advisory services network gaming platform. For instance, while viewing an item of evidence at 1530, the player can provide input for which a game response is to navigate to discussion thread, at 1570, associated with or related to the item of evidence. Accordingly, the player is not limited to merely adding the item of evidence to the dossier as a multitude of actions can be taken upon viewing the item of evidence. In another example, submitting a solution, at 1560, can start a discussion thread which is navigated to at 1570. The game can continue to loop as shown in FIG. 15, wherein the player continues to navigate the narrative, provide input, participate in discussions, etc., until the player exits the game and/or a ending point within the game is reached.

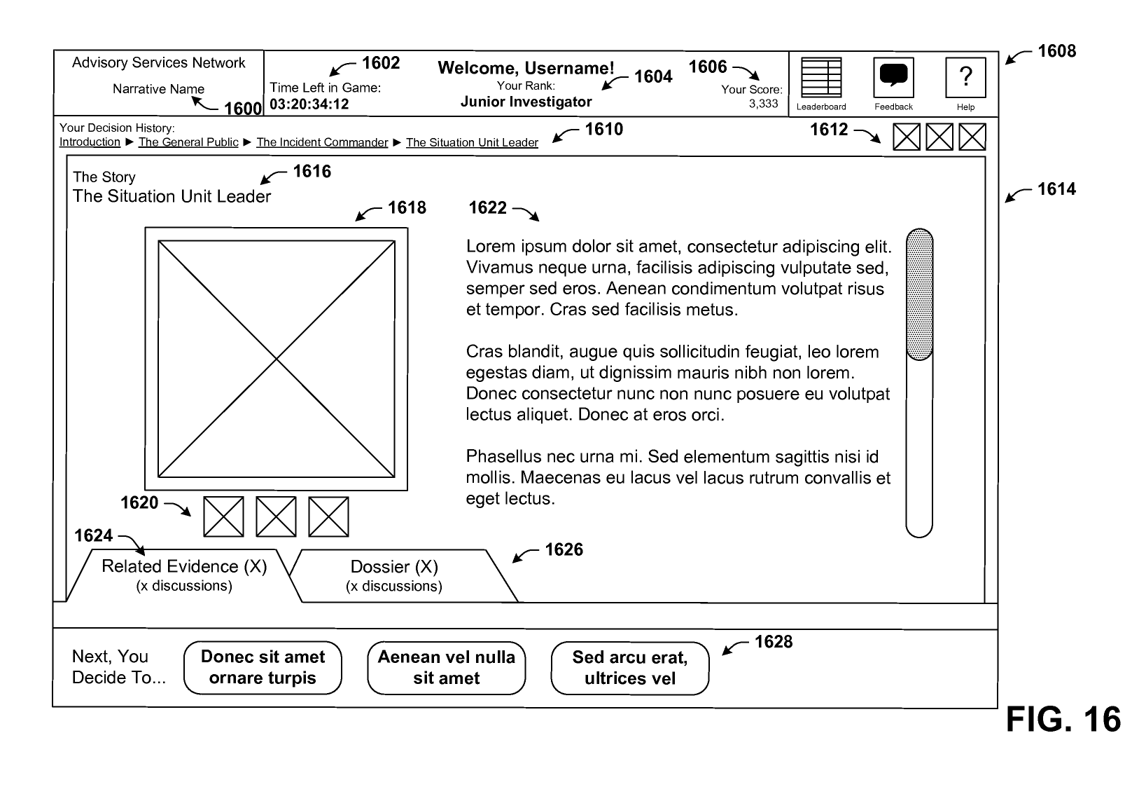

Referring to FIG. 16, an exemplary, non-limiting illustration of a user interface of a gaming environment of an advisory services network. The user interface can be deployed on a standalone application executing on an operating system of a computer or as web-based application executing on a web server and accessed via a web browser. As shown in FIG. 16, the user interface can include a wide array of sections presenting a variety of information. At 1600, a logo or name of the system (e.g., “Advisory Services Network”) can be displayed along with a name of specific game instance or narrative. In a specific, non-limiting example, the narrative name can be a name or identity of an organization whose complex problem is modeled by the game instance. In another example, the narrative name can be more descriptive and hint or suggest the complex problem of the organization.

At 1602, an indication of time remaining in the game can be displayed. The organization with the complex problem can have a time limit by which it would desire a potential solution to be presented. Such time limit can translate into time duration of the game as shown at 1602. At 1604, a header portion with header information can be presented. In FIG. 16, header information, in a specific, non-limiting example, can include a greeting and a rank provided to the player in the game. At 1606, the player's score can be shown. The score can be utilized to indicate a significance of a player's contribution in the game and/or to serve as a basis to distribute intrinsic and extrinsic rewards to the player.

At 1608, various game support functions can be presented as a series of buttons. For instance, support functions, when selected, can open up modal displays with appropriate controls. As shown in FIG. 16, some exemplary support functions include a leaderboard function, a feedback function, and a help function. At 1610, navigational breadcrumbs are depicted. The navigational breadcrumbs serve a dual purpose. Not only do the navigational breadcrumbs indicate a current scene viewed by the player, but the navigational breadcrumbs also depict the choices or path taken by the player to arrive at the current scene. At 1612, a list of other players who have played through the current scene. As shown in FIG. 16, and in accordance with one exemplary, non-limiting embodiment, the list of players can be depicted as a series of thumbnail images of avatars or other identifiers associated with the players. This information can enable a player to research other choices, actions, or input from other players regarding the current scene and evidence.

In FIG. 16, numeral 1614 indicates a main content portion of the user interface. Within the main content portion, a scene title (1616) can be displayed along with any imagery related to the scene, shown as a primary image at 1618 with alternative thumbnail images at 1620. Further, a scene narrative, shown at 1622, can be presented along with a scrollbar when the narrative extends beyond a viewable pane of the user interface.

At 1624, a related evidence tab is displayed, which can be activated to display a list of evidence supporting the current scene. The tab label, as shown in FIG. 16, can provide an indication of a number of evidence items as well as an indication of a number of discussion threads related to the evidence items. At 1626, a dossier tab is depicted which enables access to the player's dossier. The tab label of the dossier tab indicates a number of items included in the player's dossier as well as a number of discussions pertaining to the player's dossier. At 1628, a series of navigational options are provided to the player. The navigational options present scenes to which the player can navigate to from the current scene.

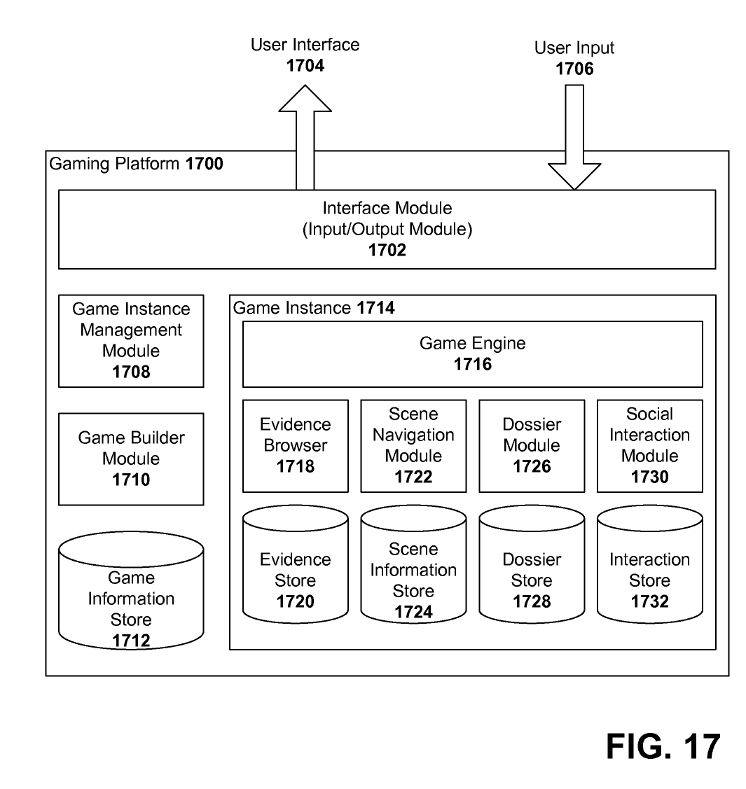

FIG. 17 is a block diagram illustrating an exemplary, non-limiting gaming platform 1700 in accordance with one or more embodiments. Gaming platform 1700, as shown in FIG. 17, can include an interface module 1702 (also referred to as an input/output module). Interface module 1702 can be configured to accept input from players (e.g., members of diverse group), to coordinate handling of input among a variety of gaming instance and subsystems thereof, and to provide generated output back to players. For example, interface module 1702 can obtain evidence, which can include ethnographic information, a variety of media, documents, case studies, etc., related to a complex problem of a sponsor for which the gaming platform 1700, and particularly game instance 1714, is deployed to solve. In addition to the evidence, interface module 1702 can obtain game configuration information which customizes game instance 1714. Once obtained by interface module 1702, the configuration information can be employed by a game builder module to instantiate game instance 1714. For example, game builder module 1710 can create a data structure that represents game instance 1714 and configure the data structure based upon the configuration information (e.g., configure a game engine 1716 of game instance 1714). In addition, the game builder module 1710 can index the evidence and store the evidence in an evidence store 1720 of game instance 1714. Game instance 1714, generated by game builder module 1710, can be stored in game information store 1712 and managed by game instance management module 1708 that manages game instances in association with sponsors supporting the game (e.g., an organization with a complex problem to be solved via the game). In an embodiment, gaming platform obtains the evidence from a sponsor of game instance 1714. According to an example, the sponsor can be organization with a complex problem that gaming platform 1700 solves through crowd sourcing via game instance 1714. The sponsor provides the evidence to convey a context of the complex problem and a deep understanding of the complex problem.

Interface module 1702 can generate and maintain a user interface 1704 configured to convey information to players and provide means for players to generate and send user input 1706 to gaming platform 1700. User interface 1704 generated by interface module 1702 can incorporate information provided by game engine 1716 of game instance 1714 or game instance management module 1708 depending on a state of gaming platform 1700 from a players perspective. For example, when user interface 1704 displays a lobby setting, the game instance management module 1708 determines the content of user interface 1704. The content, in one example, can be information globally stored (e.g., independently from specific game instances) in game information store 1712 and globally managed by game instance management module 1708. For instance, while displaying the lobby, user interface 1704 can display a listing of games available (e.g., game instances available) along with labels to indicate games a particular player has already played, games the particular player has not played, and/or new games. The user interface 1704, in lobby mode, further provides mechanisms to enable players to join a new game, enter a game, exit a game, etc.

When user interface 1704 displays content regarding a specific game, such content is provided by a game engine of the corresponding game instance such as, for example, game engine 1716 of game instance 1714. In one embodiment, when displaying content from a game, user interface 1704 can be similar to user interface 1600 described above with reference to FIG. 16. Interface module 1702 is further configured to dispatch user input 1706 to an appropriate entity based upon the mode of user interface 1704.

User input 1706 can encompass a variety of requests, commands, or information to be handled by the gaming platform 1700 and subsystems therein. For example, while in lobby mode, user input 1706 can be provided to game instance management module 1708 for handling. In an embodiment, user input 1706 can include a command to enter a game. In response, game instance management module 1708 loads the game instance from game information store 1712 associated with the selected game instance specified in user input 1706 such as game instance 1714. In addition, game instance management module 1708 further instructs interface module 1702 to change the user interface mode to a game specific mode and to update user interface 1704 to contain content pulled from game instance 1714. Thereafter, user input 1706 is forwarded to game instance 1714, and in particular to game engine 1716 of game instance 1714.

User input 1706 can encompass a variety of requests, commands, or information to be handled by game instance 1714 and subsystems therein. For instance, user input 1706 can include a request to view an item of evidence. Interface module 1702, when the request to view the item of evidence is received, engages a browser module 1718 of the appropriate gaming instance (game instance 1714 in FIG. 17) via a corresponding game engine 1716, which queries evidence store 1720 to obtain the requested item of evidence. The obtained item of evidence can be forwarded to interface module 1702 to be presented through user interface 1704.

In another example, user input 1706 can include a navigational command such as a request to view a different area, scene, or narrative of game instance 1714. The navigational command is dispatched, by game engine 1716, to a scene navigation module 1722, which queries a scene information store 1724 to obtain a game scene requested in navigational command. The game scene can be forwarded, via game engine 1716, to interface module 1702 to update user interface 1704.

In another example, user input 1706 can include a social interaction such as a command to create a discussion thread, a comment on a an existing discussion thread, a message sent to another user, a chat sent to another user, a linking of a media item to a discussion thread or comment on a discussion thread, a linking of a discussion thread to another discussion thread via a comment or other mechanism, or any other user action and content directed towards other users, interactions with media items, responses or interactions with previous social interactions, etc. Interface module 1702 can utilize a social interaction module 1730 of gaming instance 1714 to process the social interaction, generate metadata associated with the social interaction, record the social interaction and metadata in an interaction store 1732, and/or modify metadata associated with previous social interactions stored in interaction store 1732, to indicate relationships formed as a result of the social interaction. Further, social interaction module 1730 can direct interface module 1702 to transmit a message to other users based upon the social interaction. For example, interface module 1702 can send an e-mail message, an instant message, an SMS message, an MMS message, etc. to other users in response to the social interaction. For instance, the social interaction can be a comment on an existing discussion thread. In response, the interface module 1702 can transmit a message to a user responsible for creating the discussion thread that the comment has been made. Further, the message can include the content of the comment as well.

In yet another embodiment, user input 1706 can include a dossier command. As described above, the dossier can capture a user's perspective which is influenced by the background, experiences, skills, etc. of the player. Accordingly, with a large and diverse group of players, the resultant set of dossiers provides a variety of viewpoints which facilitates articulation of root problems and launch pads for high-quality solutions to those root problems. In a specific, non-limiting example, the dossier functions as a personal collection of evidence items built by players of gaming platform 1700 and in particular players of game instance 1714. The user can review evidence items stored in evidence store 1720 related to a complex problem and select specific items which the user believes represents the complex problem. The dossier enables the user to build a case on the complex problem by adding evidence to the dossier, removing evidence from the dossier, organizing evidence in the dossier, tagging evidence in the dossier, annotating evidence in the dossier, etc. The dossier can be shared with other user and/or experts also participating in gaming platform 1700.

As shown in FIG. 17, game instance 1714 includes a dossier module 1726 which manages a set of dossiers stored in dossier store 1728. In one embodiment, each player of game instance 1714 can be associated with a respective dossier. Interface module 1702, upon recognizing a dossier command in user input 1706, can forward the command to dossier module 1726, via game engine 1716, which is configured to modify a dossier stored in dossier store 1728 in response to the dossier command.

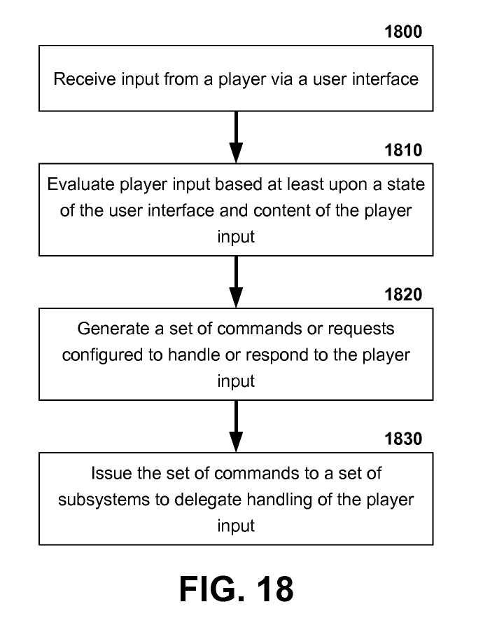

Turning to FIG. 18, a flow diagram of an exemplary, non-limiting embodiment for interacting with a player of a game via player input is illustrated. At 1800, input is received from a player via a user interface. At 1810, the player input is evaluated based at least upon a state of the user interface and a content of the player input. At 1820, a set of commands is generated to handle or responds to the player input. At 1830, the set of commands are issued to a set of subsystems to delegate handling of the player input.

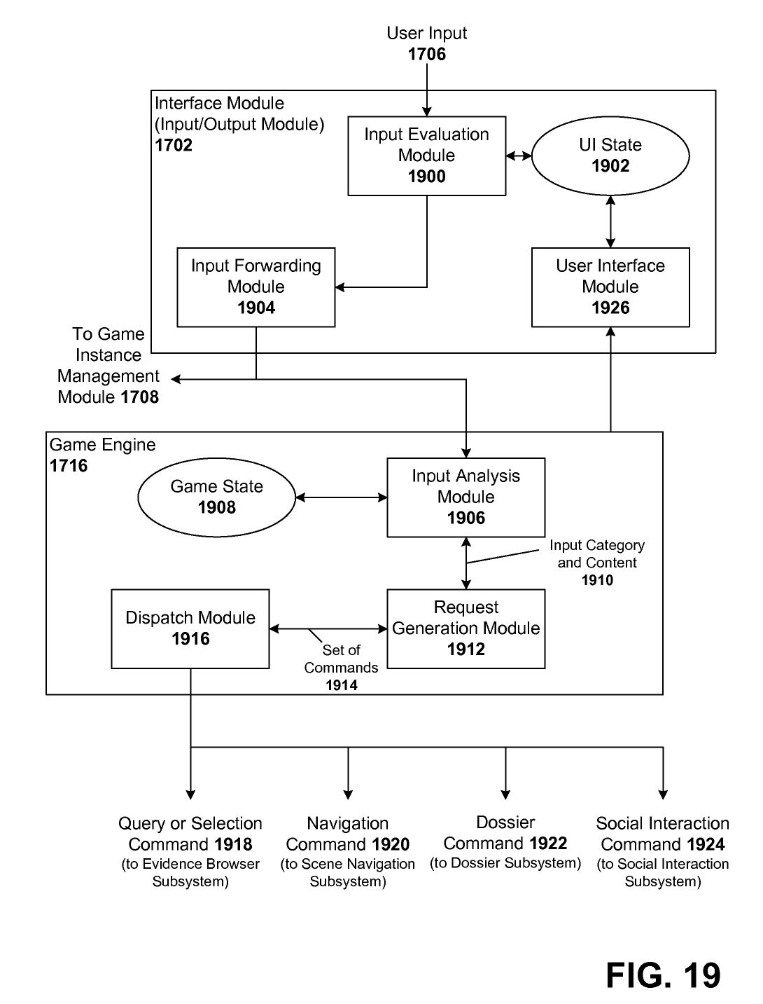

FIG. 19 is a block diagram of an exemplary, non-limiting act of handling player input. According to an example, FIG. 19 illustrates at least the method described above with reference to FIG. 18. As shown in FIG. 19, user input 1706 is obtained by interface module 1702 which includes an input evaluation module 1900 configured to determine a destination of user input 1706 based upon a user interface (UI) state 1902. UI state 1902 indicates whether the user interface is in a lobby mode or a game mode. When in a lobby mode, which is global mode of gaming platform 1700 independent of specific game instances, user input 1706 is forwarded to game instance management module 1708 by input forwarding module 1904. However, when UI state 1902 indicate a game-specific mode, input forwarding module 1904 conveys user input 1706 to game engine 1716 of game instance 1714. Game engine 1716, in an aspect, includes an input analysis module 1906 that, based upon, a game state 1908, determines an input category and content 1910. The game state 1908 can indicate a currently active narrative scene, a currently displayed screen of the user interface, etc., from which an intent or purpose of user input 1706 can be derived. A request generation module 1912, based upon the input category and content 1910, creates a set of commands 1914 for one or more subsystems of game instance 1714. The set of commands are provided to a dispatch module 1916 configured to forwards commands in the set of commands 1914 to one or more subsystems. For instance, the set of commands can include a query or selection command 1918 sent to an evidence browser subsystem, a navigation command 1920 sent to a scene navigation subsystem, a dossier command 1922 sent to a dossier subsystem, or a social interaction command 1924 sent to a social interaction subsystem. Based upon responses from respective subsystems, game engine 1716 can instruct user interface module 1926 of interface module 1702 to update a user interface.

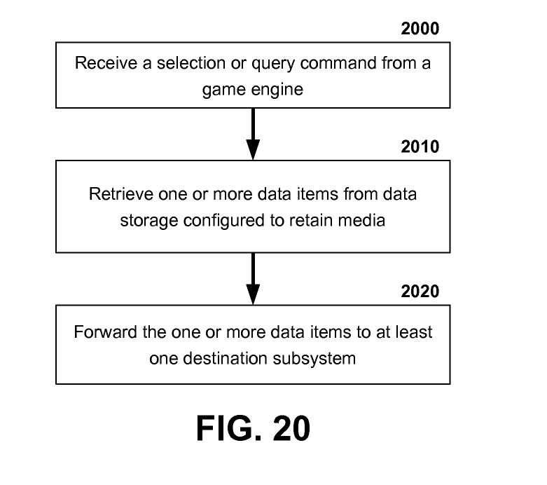

FIG. 20 is a flow diagram illustrating an exemplary, non-limiting embodiment for browsing evidence items stored in a game on an advisory services network. At 2000, a selection or query command is received from a game engine. At 2010, one or more data items are retrieved from data storage configured to retain media. At 2020, the one or more data items are forwarded to at least one destination subsystem. In an example, the destination subsystem can include a game engine which to update a user interface, a dossier subsystem to include the one or more data items in a dossier, or a social interaction subsystem to incorporate the one or more data items into social interactions.

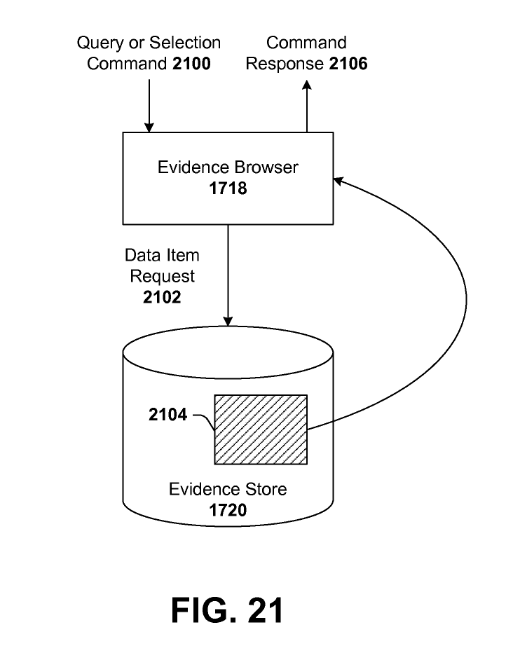

FIG. 21 is a block diagram illustrating an exemplary, non-limiting act of browsing evidence within a game on an advisory services network. In an aspect, FIG. 21 illustrates the method described above with reference to FIG. 20. As shown in FIG. 21, a query or selection command 2100 is received by an evidence browser 1718. Included in the query or selection command 2100 can be a request for a particular piece of evidence stored in evidence store 1720. Based upon that request, evidence browser 1718 issues a data item request 2102 to evidence store 1720 to obtain data item 2104 (e.g., an item of evidence), which can be forwarded on as command response 2106.

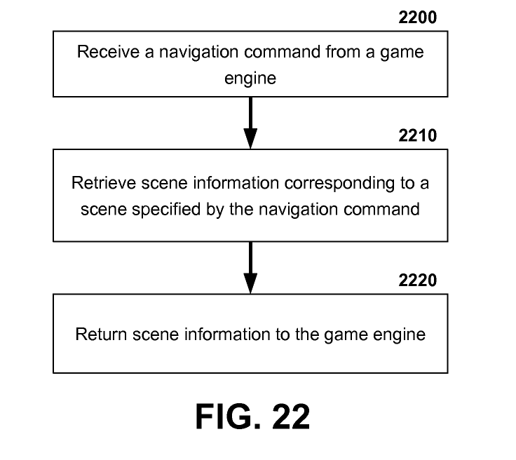

FIG. 22 is a flow diagram of an exemplary, non-limiting embodiment for navigating between scenes of a game of an advisory services network. At 2200, a navigation command is received from a game engine. At 2210, scene information corresponding to a scene specified by the navigation command is retrieved. At 2220, the scene information is returned to the game engine.

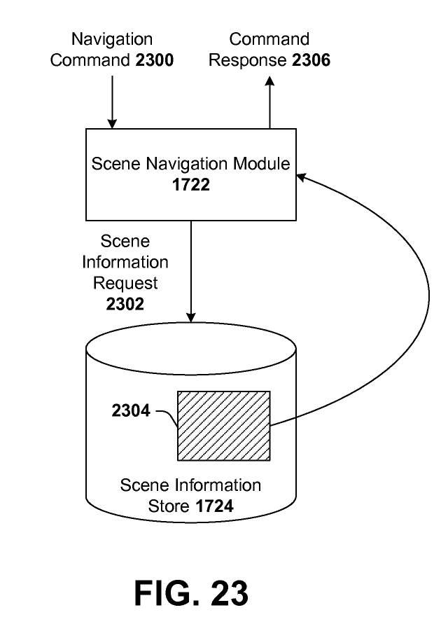

FIG. 23 is a block diagram of an exemplary, non-limiting act of navigating between scenes of a game of an advisory services network. In an aspect, FIG. 23 illustrates the method described above with reference to FIG. 22. As shown in FIG. 23, a navigation command 2300 is received by a scene navigation module 1722. Included in the navigation command 2300 can be a request for a particular narrative scene stored in scene information store 1724. Based upon that request, scene navigation module 1722 issues a scene information request 2302 to scene information store 1724 to obtain scene 2304, which can be forwarded on as command response 2306.

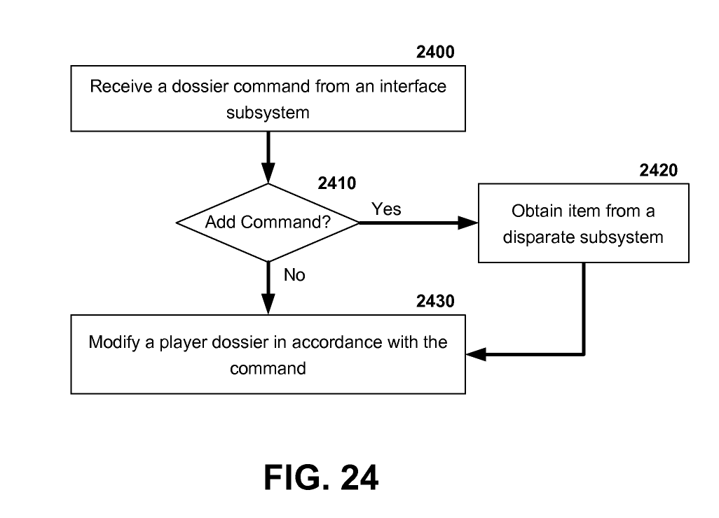

FIG. 24 is a flow diagram of an exemplary, non-limiting embodiment for managing a digital dossier within a game of an advisory services network. At 2400, a dossier command is received from a game engine. At 2410, a determination is made as to whether the dossier command is an add command. If yes, at 2420, an item is obtained from a disparate subsystem. After obtaining the item, a player dossier is modified in accordance with the dossier command at 2430. If, at 2410, the dossier command is not an add command, the command is executed at 2430.

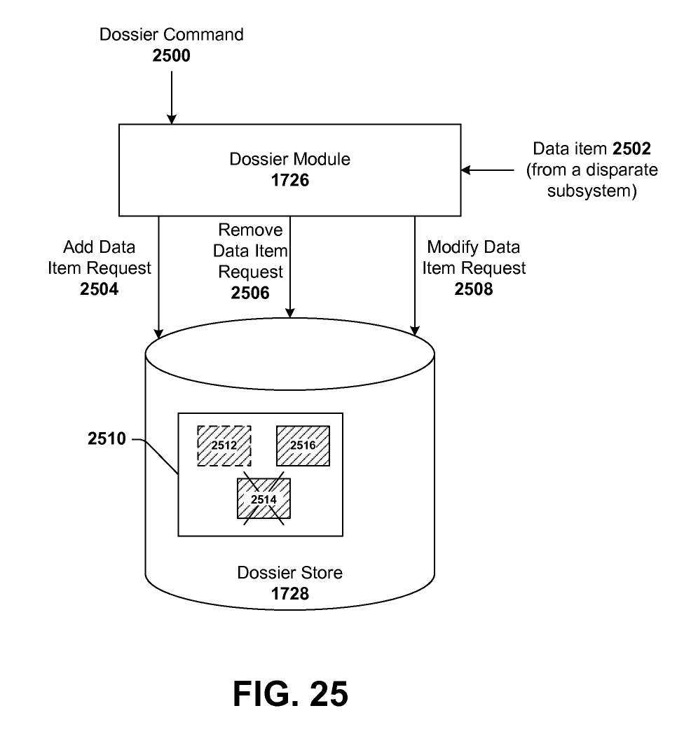

FIG. 25 is a block diagram illustrating an exemplary, non-limiting act of managing a digital dossier within a game of an advisory services network. A dossier command 2500 can be received by dossier module 1726. In an example, the dossier command can be an add command wherein a data item (e.g., a dossier, a piece of evidence, a narrative scene, a discussion thread, etc.) is added to a player's dossier. Accordingly, dossier module 1726 can also retrieve data item 2502 from a disparate subsystem (e.g., dossier subsystem, browsing subsystem, scene navigation subsystem, social interaction subsystem, etc.). In one aspect, the set of commands dispatched from game engine 1716 as shown in FIG. 19 can include the commands to retrieve data item 2502 and provide it to dossier module 1726.

Based upon dossier command 2500, the dossier module 1726 can interact with dossier store 1728, and in particular dossier 2510 stored therein, in a variety of ways. For instance, dossier module 1726 can send an add data item request 2504 which instructs dossier store 1728 to incorporate data item 2502 into dossier 2510 as dossier item 2512. In another example, dossier module 1726 can transmit a remove data item request 2506 which instructs dossier store 1728 to remove dossier item 2514 from dossier 2510. Further, dossier command 2500 can specify metadata (e.g., groups, ordering commands, tags, etc.) which dossier module 1726 forwards as a modify data item request 2508 so that dossier store 1728 can modify metadata associated with a dossier item 2516.

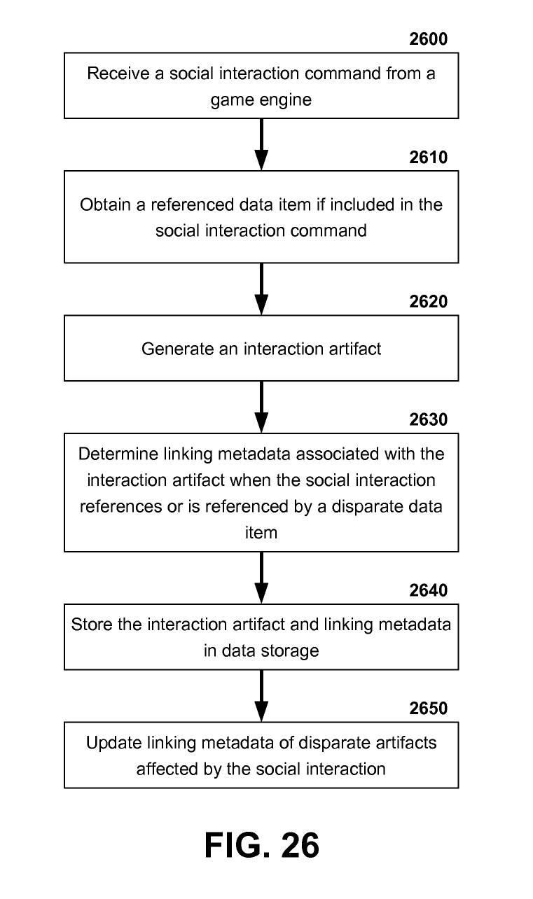

FIG. 26 is a flow diagram illustrating an exemplary, non-limiting embodiment for managing social interactions within a game of an advisory services network. At 2600, a social interaction command is received from a game engine. At 2610, a reference data item, if included in the social interaction command, is obtained. At 2620, an interaction artifact is generated, wherein the interaction artifact memorializes the social interaction, the content of the social interaction, and the position of the social interaction among other social interactions (e.g., position relative to the big picture of social interactions made via gaming platform 1700 and/or relationships with other interactions artifacts. At 2630, linking metadata associated with the interaction artifact is determined when the social interaction command references or is referenced by a disparate data item (e.g., the reference data item obtained at 2610). The linking metadata specifies the relationship between the social interaction (or the artifact generated therefrom) and the referenced data item. At 2640, the interaction artifact, with linking metadata attached thereto, is stored in data storage. At 2650, linking metadata of disparate artifacts, already stored in data storage and affected by the social interaction, is updated.

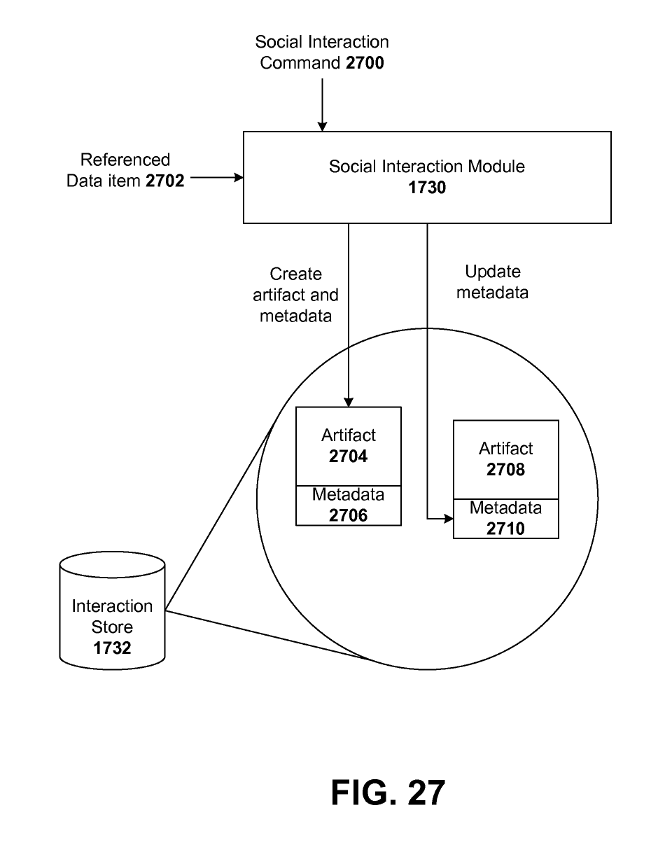

FIG. 27 is a block diagram illustrating an exemplary, non-limiting act of managing social interactions within a game of an advisory services network. A social interaction command 2700 is received by a social interaction module 1730, wherein the social interaction command 2700 represents a social interaction originating from a player. In one aspect, the social interaction can reference a data item which is input to social interaction module 1730 as referenced data item 2702. Based upon the social interaction command 2700 and/or the referenced data item 2702, social interaction module 1730 creates artifact 2704 and associated metadata 2706 and stores artifact 2704 and metadata 2706 in interaction store 1732. Further, when referenced data item 2702 is another artifact 2708 or when creation of artifact 2704 affects artifact 2708 (e.g., artifact 2704 is a comment on a discussion thread represented by artifact 2708), social interaction module 1730 updates metadata 2710 associated with artifact 2708 to indicate that effect.

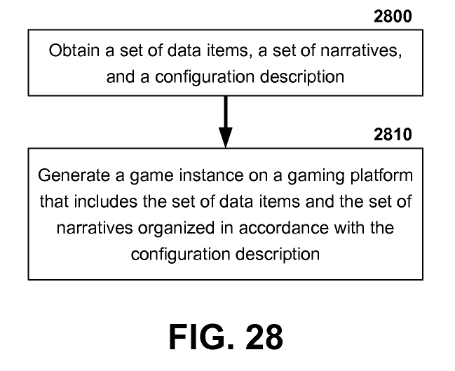

FIG. 28 is a flow diagram illustrating an exemplary, non-limiting embodiment for creating a game instance within an advisory services network. At 2800, a set of data items, a set of narratives, and a configuration description are obtained. At 2810, a game instance on a gaming platform is generated, wherein the game instance includes the set of data items and the set of narratives organized in accordance with the configuration description.

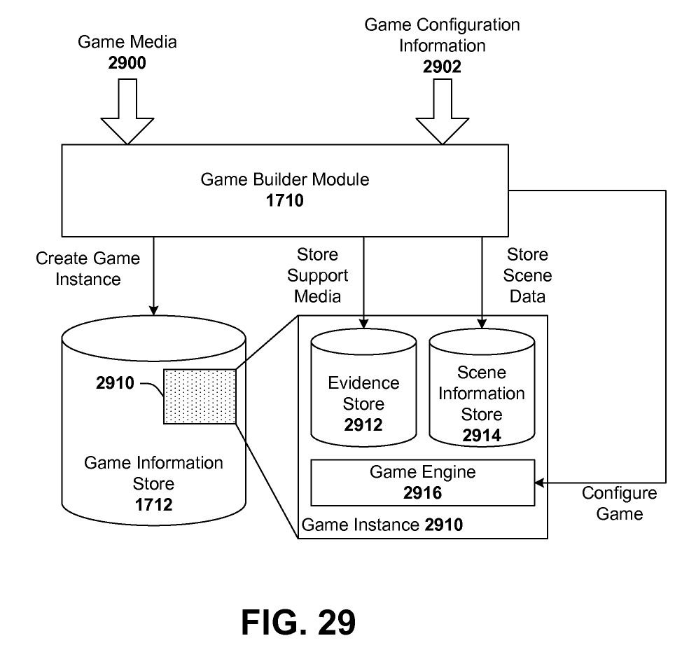

FIG. 29 is a block diagram of an exemplary, non-limiting act of building a game instance within an advisory services network. As shown in FIG. 29, a game builder module 1710 obtains game media 2900, which can include a set of media items and a set of scene narratives, and game configuration information 2902 that specifies rules of a game, a setting of game, a points system of the game, how scenes are organized with respect to each other, and how evidence items are organized with respect to the scenes.

Game builder module 1710 generates a data structure, stored in game information store 1712, which represents a game instance 2910. As shown in FIG. 29, the game instance 2910 can include evidence store 2912, a scene information store 2914, and a game engine 2916. The game builder module 1710 stores support media, e.g., evidence, included in game media 2900 in evidence store 2912 of game instance 2910 and scene data in scene information store 2914. In addition, game builder module 1710 configures game engine 2916 in accordance with game configuration information 2902.

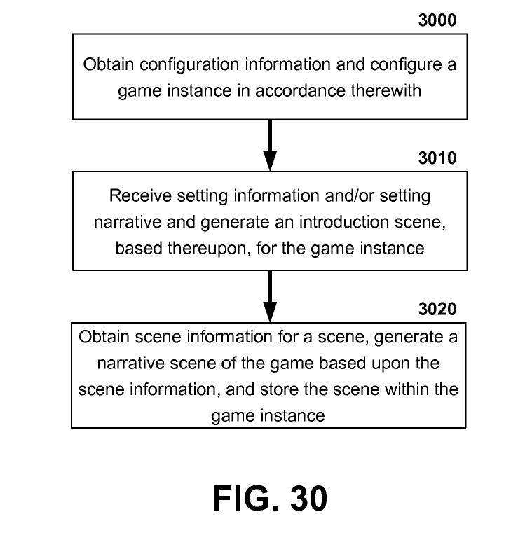

FIG. 30 is a flow diagram of an exemplary, non-limiting embodiment of building a game instance within a gaming platform of an advisory services network. At 3000, configuration information is obtained and a game instance is configured in accordance therewith. At 3010, setting information and/or setting narrative are received and an introduction scene, based thereupon, is generated for the game instance. At 3020, scene information for a scene is obtained, a narrative scene of the game is generated based upon the scene information, and the scene is stored within the game instance.

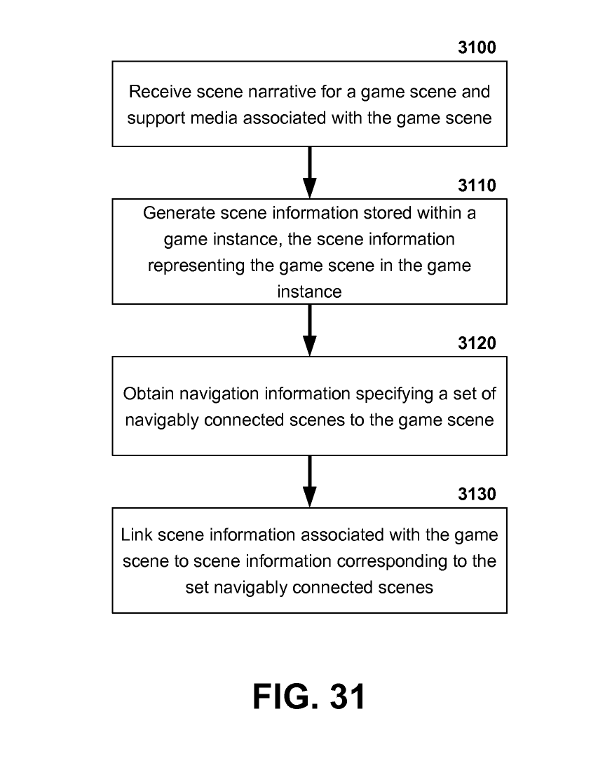

FIG. 31 is a flow diagram illustrating an exemplary, non-limiting embodiment for creating a narrative scene of a game instance within an advisory services network. At 3100, a scene narrative for a game scene and support media associated with the game scene are received. At 3110, scene information to be stored within a game instance is generated, wherein the scene information represents the game scene within the game instance. At 3120, navigation information is obtained, wherein the navigation information specifies a set of navigably connected scenes to the game scene. At 3130, the scene information is linked to scene information corresponding to the set of navigably connected scenes.

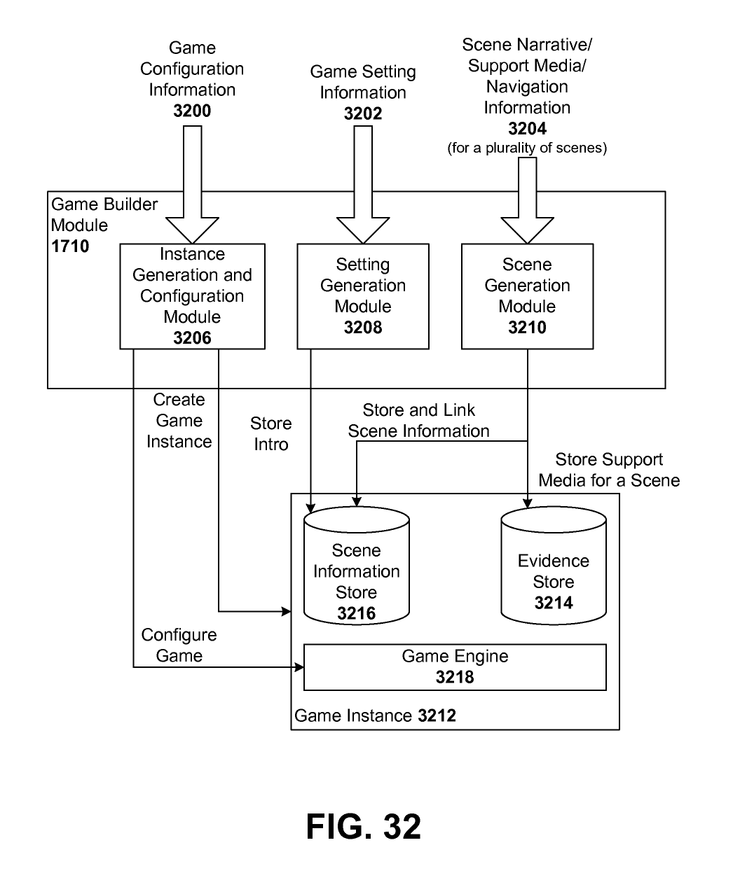

FIG. 32 is a block diagram illustrating an exemplary, non-limiting act of building a game instance within an advisory services network. As shown in FIG. 32, a game builder module 1710 obtains game configuration information 3200 and employs an instance generation and configuration module 3206 which creates game instance 3212 and configures a game engine 3218 of game instance 3212 based upon the game configuration information 3200. Game builder module 1710 includes a setting generation module 3208 that generates an introduction based upon game setting information 3202, wherein the introduction establishes a setting (e.g., a story setting, a game objective, etc.) of game instance 3212. The introduction is stored as an introductory scene in scene information store 3216. Game builder module 1710 can also include scene narrative/support media/navigation information 3204 for one or more scenes. A scene generation module 3210 that generates one or more scenes based upon the scene narrative/support media/navigation information 3204 received by game builder module 1710. In particular, scene generation module 3210 generates scene information for each scene, stores the scene information in scene information store 3216, stores support media for each in evidence store 3214, and links scene information to other scene information to construct an order of scenes.

### Exemplary Networked and Distributed Environments

One of ordinary skill in the art can appreciate that the various embodiments of advisory services network systems and methods described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the advisory services network and gaming platform as described for various embodiments of the subject disclosure.

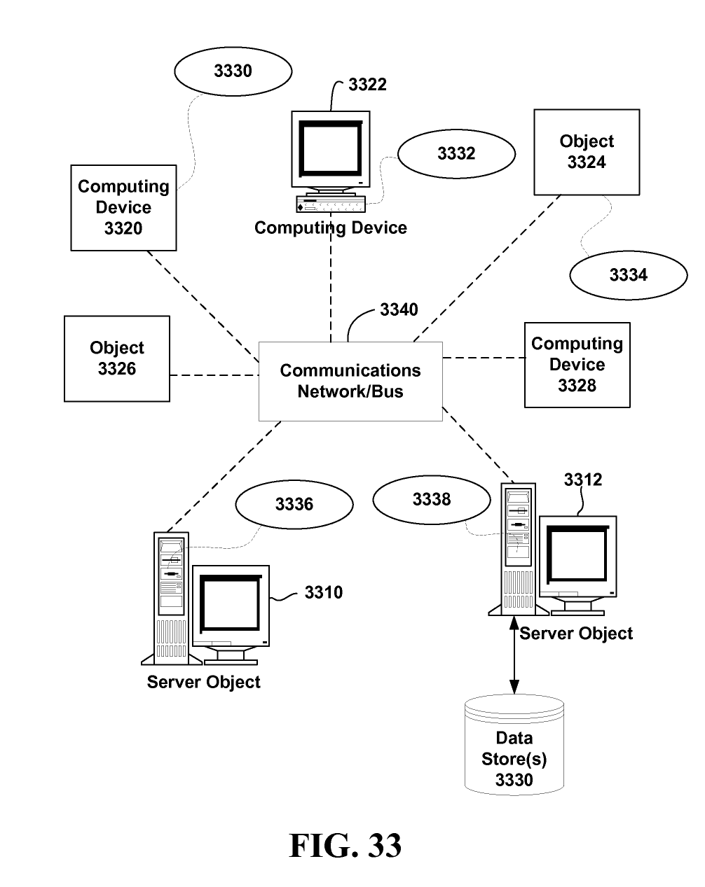

FIG. 33 provides a schematic diagram of an exemplary networked or distributed computing environment. The distributed computing environment comprises computing objects 3310, 3312, etc. and computing objects or devices 3320, 3322, 3324, 3326, 3328, etc., which may include programs, methods, data stores, programmable logic, etc., as represented by applications 3330, 3332, 3334, 3336, 3338. It can be appreciated that computing objects 3310, 3312, etc. and computing objects or devices 3320, 3322, 3324, 3326, 3328, etc. may comprise different devices, such as personal digital assistants (PDAs), audio/video devices, mobile phones, MP3 players, personal computers, laptops, etc.

Each computing object 3310, 3312, etc. and computing objects or devices 3320, 3322, 3324, 3326, 3328, etc. can communicate with one or more other computing objects 3310, 3312, etc. and computing objects or devices 3320, 3322, 3324, 3326, 3328, etc. by way of the communications network 3340, either directly or indirectly. Even though illustrated as a single element in FIG. 33, communications network 3340 may comprise other computing objects and computing devices that provide services to the system of FIG. 33, and/or may represent multiple interconnected networks, which are not shown. Each computing object 3310, 3312, etc. or computing object or device 3320, 3322, 3324, 3326, 3328, etc. can also contain an application, such as applications 3330, 3332, 3334, 3336, 3338, that might make use of an API, or other object, software, firmware and/or hardware, suitable for communication with or implementation of the advisory services network and associated mechanisms in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 33, as a non-limiting example, computing objects or devices 3320, 3322, 3324, 3326, 3328, etc. can be thought of as clients and computing objects 3310, 3312, etc. can be thought of as servers where computing objects 3310, 3312, etc., acting as servers provide data services, such as receiving data from client computing objects or devices 3320, 3322, 3324, 3326, 3328, etc., storing of data, processing of data, transmitting data to client computing objects or devices 3320, 3322, 3324, 3326, 3328, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 3340 or bus is the Internet, for example, the computing objects 3310, 3312, etc. can be Web servers with which other computing objects or devices 3320, 3322, 3324, 3326, 3328, etc. communicate via any of a number of known protocols, such as the hypertext transfer protocol (HTTP). Computing objects 3310, 3312, etc. acting as servers may also serve as clients, e.g., computing objects or devices 3320, 3322, 3324, 3326, 3328, etc., as may be characteristic of a distributed computing environment.

### Exemplary Computing Device

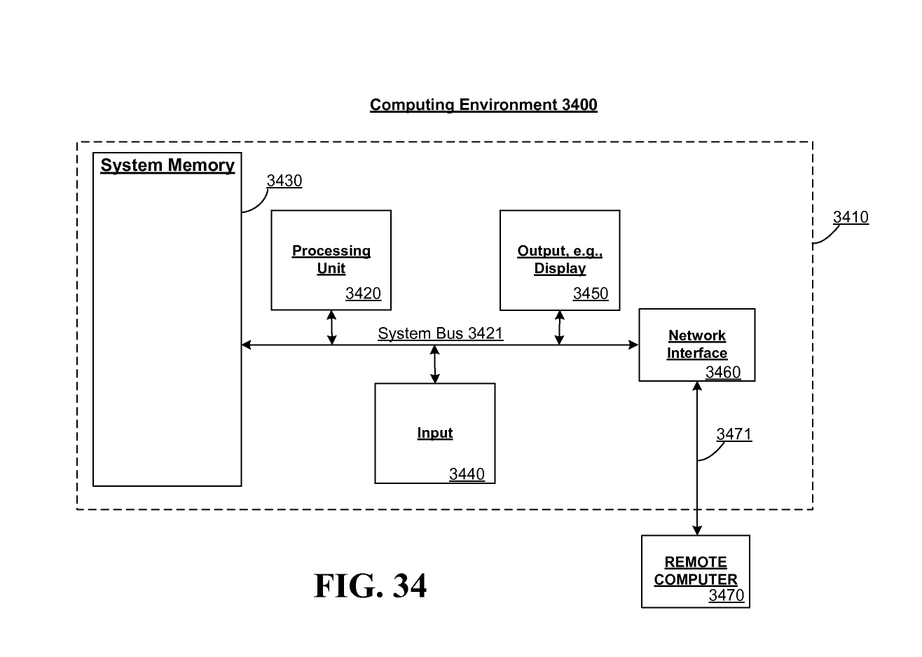

As mentioned, advantageously, the techniques described herein can be applied to any device where it is desirable to solve real-world problems in a computing system supporting the gaming environment described herein. It can be understood, therefore, that handheld, portable and other computing devices and computing objects of all kinds are contemplated for use in connection with the various embodiments, i.e., anywhere that where users can access the gaming environment. Accordingly, the below general purpose remote computer described below in FIG. 34 is but one example of a computing device.

Embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 34 thus illustrates an example of a suitable computing system environment 3400 in which one or aspects of the embodiments described herein can be implemented, although as made clear above, the computing system environment 3400 is only one example of a suitable computing environment and is not intended to suggest any limitation as to scope of use or functionality. In addition, the computing system environment 3400 is not intended to be interpreted as having any dependency relating to any one or combination of components illustrated in the exemplary computing system environment 3400.

With reference to FIG. 34, an exemplary remote device for implementing one or more embodiments includes a general purpose computing device in the form of a computer 3410. Components of computer 3410 may include, but are not limited to, a processing unit 3420, a system memory 3430, and a system bus 3422 that couples various system components including the system memory to the processing unit 3420.

Computer 3410 typically includes a variety of computer readable media and can be any available media that can be accessed by computer 3410. The system memory 3430 may include computer storage media in the form of volatile and/or nonvolatile memory such as read only memory (ROM) and/or random access memory (RAM). By way of example, and not limitation, system memory 3430 may also include an operating system, application programs, other program modules, and program data. According to a further example, computer 2610 can also include a variety of other media (not shown), which can include, without limitation, RAM, ROM, EEPROM, flash memory or other memory technology, compact disk (CD) ROM, digital versatile disk (DVD) or other optical disk storage, magnetic cassettes, magnetic tape, magnetic disk storage or other magnetic storage devices, or other tangible and/or non-transitory media which can be used to store desired information.

A user can enter commands and information into the computer 3410 through input devices 3440. A monitor or other type of display device is also connected to the system bus 3422 via an interface, such as output interface 3450. In addition to a monitor, computers can also include other peripheral output devices such as speakers and a printer, which may be connected through output interface 3450.

The computer 3410 may operate in a networked or distributed environment using logical connections to one or more other remote computers, such as remote computer 3470. The remote computer 3470 may be a personal computer, a server, a router, a network PC, a peer device or other common network node, or any other remote media consumption or transmission device, and may include any or all of the elements described above relative to the computer 3410. The logical connections depicted in FIG. 34 include a network 3472, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to implement a game for real-world application.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. An advisory services system, comprising:
an evidence store configured to retain a set of media items related to a real-world problem of an entity;
a browsing module configured to retrieve an item from the set of media items stored in the evidence store and provide the item retrieved for review by a user of the advisory services system;
a social interaction module configured to manage a discussion board through which a plurality of users drawn from a diverse group engage in communications regarding media items in the set of the media items stored by the evidence store; and
an interaction store configured to retain artifacts generated from interaction input from the plurality of users, wherein the artifacts represent the communications hosted on the discussion board,
wherein the browsing module and the social interaction module enable the plurality of users to collaborate to devise a solution for the real-world problem of the entity.

2. The advisory services system of claim 1, further comprising an evidence index module configured to receive the set of media items from the entity and store the set of media items in the evidence store.

3. The advisory services system of claim 1, wherein the set of media items include ethnographic information regarding the entity and the real-world problem of the entity.

4. The advisory services system of claim 1, further comprising an interface module configured to generate a user interface displayed to the plurality of users and to obtain user input from the plurality of users,
wherein the interface module is further configured to forward the user input to one or more of the browsing module or the social interaction module based at least in part upon a content of the user input.

5. The advisory services system of claim 1, further comprising a dossier store configured to store a digital dossier associated with the user of the advisory services system, wherein the digital dossier retains one or more media items selected, in response to input from the user, from the set of media items stored in the evidence store.

6. The advisory services system of claim 5, further comprising a dossier module configured to manage the digital dossier stored in the dossier store in accordance with a dossier command received as input from the user.

7. The advisory services system of claim 6, wherein the dossier module is further configured to, in response the dossier command, at least one of add a media item from the set of media items stored in the evidence store to the digital dossier, remove items from the digital dossier, reorder items in the digital dossier, or publish the digital dossier to a discussion thread managed by the social interaction module.

8. A method facilitated by at least one processor of a computing system, comprising:
obtaining a set of media and configuration information from an entity with a real-world problem for which a solution is yet to be found;
instantiating a network game based upon the set of media and the configuration information; and
deploying the network game on a gaming platform, wherein a diverse group of players interact and collaborate via the network game to solve the real-world problem based upon the set of media.

9. The method of claim 8, wherein the instantiating the network game further comprises:
storing a set of evidence included in the set of media in an evidence store associated with the network game;
storing a set of narrative scenes include in the set of media in a scene information store of the network game;
linking the set of narrative scenes based upon the configuration information to generate a graph of narrative scenes representing a plurality of paths among the narrative scenes navigable by the diverse group of players within the network game; and
associating a subset of evidence from the set of evidence with each narrative scene from the set of narrative scenes.

10. The method of claim 8, further comprising:
receiving input from a player via a user interface of the network game;
evaluating the input based upon a state of the network game;
generating a set of commands for executing actions in response to the input; and
issuing the set of commands to a set of subsystems of the network game.

11. The method of claim 8, further comprising:
receiving a selection command from a player of the network game;
retrieving one or more items of evidence from the set of evidence stored in the evidence store based upon the selection command; and
displaying the one or more items of evidence to the player on a user interface of the network game.

12. The method of claim 8, further comprising:
receiving a navigation command from a player of the network game;
retrieving a narrative scene from the set of narrative scenes stored in the scene information store based upon the navigation command; and
displaying the narrative scene on a user interface.

13. The method of claim 8, further comprising:
receiving a dossier command from a player of the network game;
obtaining a data item from a disparate subsystem of the network game when the dossier command is an add command; and
modifying a dossier corresponding to the player based upon the dossier command.

14. The method of claim 13, wherein obtaining the data item further comprises at least one of:
obtaining an item of evidence from the set of evidence stored in the evidence store;
obtaining an artifact of a social interaction made via the network game from an interaction store; or
obtaining a second dossier corresponding to a second player.

15. The method of claim 13, wherein the modifying the dossier corresponding to the player further comprises at least one of:
adding the data item from the disparate subsystem of the network game to the dossier;
removing a first dossier item from the dossier; or
modifying metadata associated with a second dossier item from the dossier.

16. The method of claim 8, further comprising:
receiving a social interaction command from a player of the network game;
generating an interaction artifact based upon a social interaction indicated in the social interaction command; and
storing the interaction artifact in a social interaction store of the network game.

17. The method of claim 16, further comprising:
obtaining a referenced data item in response to a command in the social interaction command;
determining relationship metadata associated with the interaction artifact and the reference data item; and
storing the relationship metadata in the social interaction store in association with the interaction artifact.

18. The method of claim 17, further comprising updating relationship metadata associated with disparate interaction artifacts affected by the social interaction command form the player.

19. A gaming platform of an advisory services network, comprising:
a game engine associated with an instance of a game and configured to manage execution of the game, wherein a variety of players participate who attempt to solve a real-world problem for which a solution is yet to be found based on evidence input to the game;
a plurality of data storage locations, comprising:
an evidence data store configured to retain a collection of data related to a complex business problem faced by a sponsor of the game, wherein the collection of data includes media files conveying ethnographic information received from the sponsor;
a scene information data store configured to store a collection of narrative scenes of the game, wherein each narrative scene includes a portion of a story and is associated with a portion of the collection of data;
an interaction data store configured to store discussion threads; and
a dossier data store configured to retain digital dossiers generated by players of the game; and
a plurality of subsystems, comprising:
a browsing module configured to select items of evidence from the collection of data stored in the evidence data store;
a scene navigation module configured to retrieve a narrative scene from the scene information data store in response to navigational input;
a dossier module configured to manage and maintain the digital dossiers stored in the dossier data store; and
a social interaction module configured to manage a discussion board via which players of the game can create discussion threads and participate in discussion threads.

20. The gaming platform of claim 19, further comprising a game builder module configured to generate the instance of the game based upon the ethnographic information and configuration information received from the sponsor.
